(19) United States
(12) Patent Application Publication
(10) Pub. No.: US 2024/0125638 A1
(43) Pub. Date: Apr. 18, 2024

(54) METHODS AND SYSTEMS FOR DETERMINING THE FILL LEVEL OF A LIQUID IN A CONTAINER

(71) Applicant: BASF Coatings GmbH, Ludwigshafen am Rhein (DE)

(72) Inventors: Victor KAUPE, Muenster (DE); Volkar SCHYDLO, Muenster (DE); Manuel PRAETORIUS, Muenster (DE); Ulrich BURGBACHER

(21) Appl. No.: 18/554,381

(22) PCT Filed: Apr. 22, 2022
(86) PCT No.: PCT/EP22/60697

§ 371 Date: Oct. 6, 2023

(30) Foreign Application Priority Data
May 3, 2021 (EP) 21171864.8

(51) Int. Cl. G01F 23/296; G01F 23/80; G01F 25/20

(52) U.S. Cl. CPC G01F 23/296; G01F 23/802; G01F 25/20

(57) ABSTRACT

Disclosed herein are methods and systems for non-invasively determining the fill level in a container. Further disclosed herein are methods and systems for determining the fill level in a container using a sensor device attached to the outside of the container to generate and detect an audio signal and using the detected audio signal in combination with container specific information and a data driven model to determine the fill level in the container.

### FIELD

Aspects described herein generally relate to methods and systems for non-invasively determining the fill level of a liquid in a container. More specifically, aspects described herein relate to determining the fill level of a liquid in a container using a sensor device attached to the outside of the container to generate and detect an audio signal and using the detected audio signal in combination with container specific information and a data driven model to determine the fill level of the liquid in the container.

### BACKGROUND

Liquid and solid compounds, such as food, ingredients, beverages, chemistry, pharmacy, cosmetics, etc. are commonly stored and transported using industrial-grade reusable intermediate bulk containers (called IBCs hereinafter). Depending on the design and construction, the IBCs have a volume of 500 up to 3000 liters. IBCs can be moved with forklifts or pallet trucks and are stackable due to their design, thus rendering them especially suitable for storing liquid and solid compounds intended to be transported for further use.

IBCs are available on the market in different forms, such as composite IBCs (also called K-IBCs), plastic IBCs, flexible IBCs, foldable IBCs, and metal IBCs. The most common IBCs are composite IBCs consisting of a pallet with a plastic tank and a simple mesh cage or tubular frame around the plastic tank. The less common IBCs are rigid plastic IBCs consisting of a plastic tank, also cuboid in shape, but without a metal outer container. The bladder here is self-supporting, so it weighs considerably more and has thicker walls. Flexible IBCs (also called FIBIC or Big Bag) are used to transport solid but free-flowing products such as powders or granules and consist of a sewn polypropylene fabric optionally comprising a polyethylene inliner (film bag) located in the container. In contrast to rigid IBCs, flexible IBCs are foldable and costs for transporting empty IBCs are much lower than for rigid IBCs. Foldable IBCs allow cost-efficient transport and storage of fruit concentrates, fruit preparations, dairy products, and other liquid viscous products and, more recently, of solids such as granules or tablets. They are based on a foldable plastic container and a sterilized plastic bag (inliner) with an aseptic valve. The inliner is located in the container and can be filled with liquid. Due to its stackability, easy folding and low maintenance, foldable IBCs are particularly cost-efficient. Metal IBCs are used in almost all branches of industry in the chemical, pharmaceutical, cosmetics, food and beverage, trade, and commerce sectors for the rational handling of goods. Metal IBCs are usually made of stainless steel, for example 1.4301 or 1.4571, or aluminum. They consist of a sturdy frame in which a cuboid or cylindrical container is enclosed. IBCs of this design are permanently approved for hazardous goods, provided that regular inspection is carried out every two and a half years. Cylindrical and rectangular tanks are particularly suitable for tasks involving frequent changes of products. Since stainless steel is very easy to clean without leaving residues, these IBCs are also used as aseptic food containers. Unlike in composite or plastic IBCs, the risk of diffusion of substances stored in the IBC does not exist in a stainless-steel container.

The period of use (service life) of metal IBCs is virtually unlimited, often reaching over 20 years. In contrast, the permissible period of use for plastic drums and jerricans, rigid plastic IBCs and composite IBCs with plastic inner receptacles for the carriage of dangerous goods is normally five years from the date of their manufacture. For example, plastic IBCs must be withdrawn from circulation after the five years of use as a hazardous goods container. However, recycling of plastic IBCs can be very problematic, especially if the container has previously been used as a hazardous goods container, due to the latent risk of hazardous substances diffusing into the plastic. In contrast, recycling of metal IBCs is possible without any problems.

Special types of IBCs have been developed to manage the challenges of specific transport cases or receiving environments such as, for example, antiseptic IBCs, electrostatic discharge (ESD) or anti-static IBCs, ATEX-compliant IBCs for explosives, IBCs including inlays to avoid cleaning processes or to support hygienic requirements, coated IBCs, etc.

Most IBCs have the advantage that they can be cleaned after use and thus reused several times. Therefore, various parties may handle the IBC during its lifetime, including the manufacturer of the IBC (called IBC producer hereinafter), companies selling goods (e.g. liquid or solid materials) contained in the IBCs (also called OEM hereinafter) and companies consuming the goods inside the IBC (also called customer hereinafter). For example, the lifecycle of a liquid IBC may include the following phases:
Phase 1: an IBC producer produces an IBC or prepares a used IBC and provides it to an OEM,
Phase 2: an OEM prepares the IBC, which may include repair and cleaning of the IBC, fills the prepared IBC with liquid or solid compounds and transports the filled IBC to a customer,
Phase 3: the customer withdraws the liquid or solid compounds, for example, in one or more steps,
Phase 4: the IBC either reaches its end-of-life (also called EoL) and is discarded or the IBC is returned to the IBC producer, who performs services like cleaning and repairing or the IBC is returned to the OEM, who prepares the IBC (i.e., repeats phase 2 above).

To keep track of the IBC during the lifecycle, monitoring technologies have been developed. Such technologies in use today include sensors for detecting the fill level of an IBC, cellular machine-to-machine (M2M modems) and GPS technologies for detecting a geographic location of the IBCs, and RFID tags for identifying IBCs and their contents. Detection of fill levels may be performed by the use of sensor devices which are attached to the container. Since IBCs have to be cleaned thoroughly from the outside and the inside to remove any remaining dirt and to prevent the intermixing of residues on the inside with the new filling, thus reducing the quality of the new filling, such sensor devices must either withstand the cleaning process or must be removed prior to cleaning and reattached after the cleaning process to prevent destruction of the sensor devices by the cleaning process. Permanent attachment of sensor devices to the container may require a new certification of the container, thus detachable sensor devices have been used in combination with IBCs to determine the fill level using various techniques. One technique includes optical detection of the fill level by means of a camera. However, this is only possible if the container is transparent. Another technique includes detecting a temperature difference between the contents of the container and gas/air within the container. However, this is technique is only applicable if a temperature change is induced upon removal of content from the container. Yet another technique involves acoustic stimulation of the outside of the container by using a resonator having a defined frequency, ultrasonic devices or an actuator and analysis of the detected signal(s), for example by using trained machine learning algorithms. However, the aforementioned sensor devices have a high power consumption, thus decreasing the battery lifetime and therefore increasing the maintenance intervals of said devices. Moreover, the sensor devices needs to be in direct contact with the outside of the container to detect the signal with high accuracy, thus rendering it necessary to adapt the design of the sensor device to the design of each container. Additionally, the accuracy of the determination of the fill level using such algorithms is still not satisfactory, thus it is not possible to obtain reliable results on whether the container is empty and can be collected for refill.

In view of the aforementioned drawbacks, it would be desirable to provide a method for determining the fill level of containers, in particular IBCs, which yields reliable results on the fill level and which allows to optimize the maintenance intervals of IBCs, reduce the idle time of empty IBCs or full IBCs, consolidate transports of empty and/or full IBCs, automatically order new IBCs and take old IBCs out of service, resulting in a decrease of the total number of IBCs necessary to transport the goods to the customers as well as faster product cycles and therefore ultimately in reduced costs. Moreover, the method should be implemented in combination with existing IBCs without having to recertificate the IBCs.

### Definitions

“Digital representation” may refer to a representation of the container in a computer readable form. In particular, the digital representation of container may, e.g. be data on the size of the container, in particular data on the filling volume of the container, data on the content of the container, data on the initial filing level, filing date, data on the location of the container, data on the production date of the container, data on the number of use cycles of the container, data on the maintenance intervals of the container, data on the maximum life time of the container, expiry date of the container content, and any combination thereof.

“Liquid” refers to a compound having a liquid aggregate state under the conditions being present inside the container. The inside of the container may be heated or cooled to guarantee a liquid aggregate state of the compound(s) present inside the container.

“Communication interface” may refer to a software and/or hardware interface for establishing communication such as transfer or exchange or signals or data. Software interfaces may be e. g. function calls, APIs. Communication interfaces may comprise transceivers and/or receivers. The communication may either be wired, or it may be wireless. Communication interface may be based on or it supports one or more communication protocols. The communication protocol may a wireless protocol, for example: short distance communication protocol such as Bluetooth®, or WiFi, or long distance communication protocol such as cellular or mobile network, for example, second-generation cellular network (“2G”), 3G, 4G, Long-Term Evolution (“LTE”), or 5G. Alternatively, or in addition, the communication interface may even be based on a proprietary short distance or long distance protocol. The communication interface may support any one or more standards and/or proprietary protocols.

“Computer processor” refers to an arbitrary logic circuitry configured to perform basic operations of a computer or system, and/or, generally, to a device which is configured for performing calculations or logic operations. In particular, the processing means, or computer processor may be configured for processing basic instructions that drive the computer or system. As an example, the processing means or computer processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processing means, or computer processor may be a multicore processor. Specifically, the processing means, or computer processor may be or may comprise a Central Processing Unit (“CPU”). The processing means or computer processor may be a (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processing means or processor may also refer to one or more processing devices, such as a distributed system of processing devices located across multiple computer systems (e.g., cloud computing), and is not limited to a single device unless otherwise specified.

“Audio signal” may refer to a pulsating direct voltage in the audible range of 6 to 20.000 Hz.

“Data driven model” may refer to a model at least partially derived from data. Use of a data driven model can allow describing relations, that cannot be modelled by physico-chemical laws. The use of data driven models can allow to describe relations without solving equations from physico-chemical laws. This can reduce computational power and can improve speed. The data driven model may be derived from statistics (Statistics 4th edition, David Freedman et al., W. W. Norton & Company Inc., 2004). The data driven model may be derived from Machine Learning (Machine Learning and Deep Learning frameworks and libraries for large-scale data mining: a survey, Artificial Intelligence Review 52, 77-124 (2019), Springer). The data driven model may comprise empirical or so-called “black box models”. Empirical or “black box” model may refer to models being built by using one or more of machine learning, deep learning, neural networks, or other form of artificial intelligence. The empirical or “black box” model may be any model that yields a good fit between training and test data. Alternatively, the data driven model may comprise a rigorous or “white box” model. A rigorous or “white box” model refers to models based on physico-chemical laws. The physico-chemical laws may be derived from first principles. The physico-chemical laws may comprise one or more of chemical kinetics, conservation laws of mass, momentum and energy, particle population in arbitrary dimension, physical and/or chemical relationships. The rigorous or “white box” model may be selected according to the physico-chemical laws that govern the respective problem. The data driven model may also comprise hybrid models. “Hybrid model” refers to a model that comprises white box models and black box models, see e.g. review paper of Von Stoch et al., 2014, Computers & Chemical Engineering, 60, Pages 86 to 101.

“Data storage medium” may refer to physical and other computer-readable media for carrying or storing computer-executable instructions and/or data structures. Such computer-readable media can be any available media that can be accessed by a general-purpose or special-purpose computer system. Computer-readable media may include physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

“Database” may refer to a collection of related information that can be searched and retrieved. The database can be a searchable electronic numerical, alphanumerical, or textual document; a searchable PDF document; a Microsoft Excel® spreadsheet; or a database commonly known in the state of the art. The database can be a set of electronic documents, photographs, images, diagrams, data, or drawings, residing in a computer readable storage media that can be searched and retrieved. A database can be a single database or a set of related databases or a group of unrelated databases. “Related database” means that there is at least one common information element in the related databases that can be used to relate such databases.

“Client device” may refer to a computer or a program that, as part of its operation, relies on sending a request to another program or a computer hardware or software that accesses a service made available by a server. The server may or may not be located on another computer.

### SUMMARY

To address the above-mentioned problems in a perspective the following is proposed: a method for determining the fill level of a liquid in a container, said method comprising the steps of:
(i) attaching a sensor device to the container;
(ii) providing to a computer processor via a communication interface a digital representation of the container;
(iii) acoustically stimulating the container by means of the sensor device to generate at least one audio signal being indicative of the fill level of the liquid in the container,
(iv) detecting the generated audio signal(s) and optionally processing the detected audio signal(s);
(v) providing to the computer processor via the communication interface the detected or processed audio signal(s) being indicative of the fill level of the liquid in the container;
(vi) providing to the computer processor via the communication interface at least one data driven model parametrized on historical audio signals, historical fill levels of liquids in containers and historical digital representations of the containers,
(vii) determining, with the computer processor, the fill level of the liquid in the container based on the provided digital representation of the container, the provided audio signal and the provided data driven model(s); and
(viii) providing via the communication interface the determined fill level of the liquid in the container.

It is an essential advantage of the method according to the present invention that it allows to remotely track the lifecycle of IBCs in a flexible, reliable, efficient, and comprehensive manner. The sensor enables a digital twin approach by creating a link between container master data and product master data in real time. This link allows to draw conclusions on the origin of the liquid in the container, the life cycle of the liquid in the container and the life cycle of the container as such from a quality management perspective. The digital representation of the container is preferably provided via an identification tag present on the IBC which withstands harsh cleaning conditions, thus rendering removal of the identification tag prior to cleaning unnecessary. The sensor device can be attached to the container using detachable attachment means and can be removed prior to the cleaning process, thus rendering recertification of existing IBCs superfluous and avoiding destruction of the sensor device during cleaning operations. Use of an actuator to stimulate the container allows to easily generate the audio signal(s). Processing of the audio signal, in particular by sampling, calculation of Fourier spectrum/spectra and optional extraction of predefined features and combination of said extracted features from the Fourier spectrum/spectra prior to providing said processed signals to the data driven model, significantly increases the accuracy of the determination of the fill level by the data driven model. To further increase the accuracy of the determination, different data driven models may be used for different filling volumes of IBCs.

Further disclosed is:

The use of the method disclosed herein for
optimizing the maintenance interval of container(s) and/or
reducing the total amount of circulating containers by consolidating transportation of empty and/or full containers and/or
reducing the product cycle and/or
ordering of new container(s) and/or
taking old containers out of service.

The inventive method allows to detect the fill levels of liquids in a container easily and accurately without having to call each customer to request the actual fill level, thus providing the possibility to remotely manage the lifecycle of a container and consolidating transports of empty containers. Combining the determined fill levels with the digital representation of the container allows to predict the circulation time of a container, thus allowing to reduce the idle time of the container and therefore the time elapsing between 2 fillings. The reduced idle time allows to reduce the product cycle and to optimize production planning and maintenance intervals.

Further disclosed is:

A system for determining the fill level of a liquid in a container, comprising:
a container,
a sensor device for generating, detecting, and optionally processing at least one audio signal being indicative of the fill level of the liquid in the container;
a data storage medium storing at least one data driven model parametrized on historical audio signals, historical fill levels of liquids in containers and historical digital representations of the containers;
a communication interface for providing the digital representation of the container, the detected or processed audio signal(s) and at least one data driven model to the computer processor;
a computer processor (CP) in communication with the communication interface and the data storage medium, the computer processor programmed to:
   a. receive via the communication interface the digital representation of the container, the detected or processed audio signal(s) and the at least one data driven model;
   b. optionally process the received detected audio signal(s);
   c. determine the fill level of the liquid in the container based on the received digital representation of the container, the received detected or processed audio signal(s) and the received data driven model(s); and
   d. provide the determined fill level of the liquid in the container via the communication interface.

It is an essential advantage of the system according to the present invention that the container is not permanently modified by attachment of the sensor device, thus rendering recertification of the container comprising the sensor device or the attachment means for attaching the sensor device to the outside of the container superfluous. The components of the sensor device can be accommodated inside a weather resistant enclosure, thus protecting the sensor components from harsh environmental conditions, and preventing destruction of the sensor device. Power supply of the sensor device can be accomplished using standard industry batteries, thus avoiding attachment of external power supply or the use of a special power supply. Moreover, the sensor device is compliant with regulations of explosion protection, thus allowing it's use in combination with electrostatic discharge (ESD) or anti-static IBCs and in areas requiring the fulfilment of regulations of explosion protection. Finally, the sensor device is able to function as cache for all data acquired by the sensor device, thus avoiding data loss in case the acquired data cannot be transmitted to another device for further processing and/or storage directly after data acquisition.

Further disclosed is:
a container comprising a fill level of a liquid, wherein the fill level of the liquid is determined according to the method disclosed herein.

The disclosure applies to the systems, methods and use of the methods herein alike. All features disclosed in connection with the method equally relate to the system and the use of the method disclosed herein.

Further disclosed is a client device for generating a request to initiate the determination of a fill level of a liquid in a container at a server device,
wherein the client device is configured to provide a detected or processed audio signal being indicative of the fill level of the liquid in the container and a digital representation of the container to the server device or
wherein the client device is configured to initiate acoustic stimulation of the container by means of a sensor device and wherein the sensor device is configured to provide a detected or processed audio signal being indicative of the fill level of the liquid in the container and a digital representation of the container to the server device.

### Embodiments

Embodiments of the Inventive Method:

In an aspect, the liquid is a chemical composition. In one example, the chemical composition is a liquid coating composition or a component of a liquid coating composition. According to DIN EN 971-1:1996-09 a coating composition is a liquid, paste or solid product which, when applied to a substrate, produces a coating with protective decorative and/or other specific properties. Coating compositions can be further classified according to different criteria, such as
the main binder present in the coating composition (i.e. epoxy coating composition, polyurethane coating composition etc.),
the principal solvent present in the coating composition (i.e. solvent-borne coating composition, aqueous coating composition)
their type (i.e. powder coating composition, high solid coating composition etc.)
the application procedure used to apply the coating compositions (i.e. spray coating composition, dip coating composition etc.)
the type of film formation (i.e. 1K coating composition, 2K coating composition, baking coating composition etc.)
the type of effect (i.e. effect coating composition)
the function within a multilayer coating (i.e. electrocoating composition, primer coating composition, primer surfacer coating composition, basecoat composition, clearcoat composition)
the type of object to be coated (i.e. automotive coating composition etc.).

“Components of a coating composition” may refer to materials necessary to obtain the coating composition, for example by mixing the materials. In case of multiple components coating compositions, i.e. coating compositions prepared by mixing at least 2 components, such components may be, for example, the base varnish and the hardener component. Examples of liquid coating compositions and liquid components of coating compositions include liquid electrocoating compositions, liquid primer coating compositions, liquid primer surfacer coating compositions, liquid basecoat compositions, liquid clearcoat compositions, base varnishes, or hardener components. In another example, the chemical composition includes a cosmetic composition.

In an aspect, the container is a plastic, glass, or metal container. In one example, the container is an intermediate bulk container (IBC). The term “intermediate bulk container” or “IBC” as used herein, includes IBCs, transport tanks, bulk container, solid material container, EcoBulk® Schutz brand containers, RecoBulk® Schutz brand containers, or any suitable variation or combination of the foregoing. In some embodiments, the containers may be internally lined with one or more liners having one or more layers. In such embodiments, the container may be physically coupled to the one or more liners, for example, using ultrasonic welding, and the sensor device may be configured to factor the one or more liners when determining fill levels and other properties of the container. In another example, the container is an oil drum or a plastic or glass container not being an IBC. In yet another example, the container is a fiberglass container. With particular preference, the container is a metal IBC, in particular a single walled stainless-steel or aluminium IBC.

In an aspect, the fill level of the liquid in the container is a classifier corresponding to the container being empty or the container not being empty. Use of this classifier allows to trigger collecting of the container for cleaning and refilling. Moreover, use of this classifier results in reduced measurements of the fill level, thus significantly increasing the lifetime of the batteries of the sensor device. In an alternative aspect, the fill level of the liquid in the container is corresponding to the actual fill level and may be given in % based on the original fill volume or in the actual amount, such as in litres.

In step (i), the sensor device is attached to the container. In an aspect, the sensor device is permanently or detachably physically coupled to the outside of the container, in particular detachably physically coupled to the outside of the container. Detachable coupling of the sensor device to the outside of the container allows to prevent recertification of the container which would be necessary in case the container is permanently modified, for example by attaching the sensor device or an attachment means for the sensor device permanently to the container. Easy detachment of the sensor device allows to facilitate the cleaning process of empty containers prior to refilling because the sensor device can be removed easily prior to the cleaning process, thus avoiding damage of the sensor device during the cleaning operation.

In step (ii), a digital representation of the container is provided to a computer processor via a communication interface. In an aspect, the digital representation of the container comprises data on the size of the container, in particular data on the filling volume of the container, data on the content of the container, data on the initial filing level, filing date, data on the location of the container, data on the age of the container, data on the use cycle of the container, data on the maintenance intervals of the container, data on the maximum life time of the container, expiry date of container content, and any combination thereof.

Data on the location of the container may be obtained by locating the position of the container by means of the sensor device via a wireless communication interface, in particular WiFi, and/or via a satellite-based positioning system, in particular a global navigation satellite system, and/or via ISM technology. In one example, the sensor device may be pre-programmed with at least one cellular ID, Wi-Fi network ID, ISM location and/or GPS location, and the computer processor of the sensor device may determine when one of these parameter values has been detected via the communication interface(s) present in the sensor device. In another example, the sensor device may determine its location based on the detected satellites. In yet another example, data on the location of the container may be determined based on the WiFi or ISM frequency detected by the sensor device in combination with a database comprising the frequencies associated with a location. With preference, the sensor device uses at least two different technologies to determine data on the location of the container to guarantee that data on the location can be obtained indoors as well as outdoors.

In an aspect, the step of providing the digital representation of the container includes
attaching an identification tag to the container,
retrieving the digital representation of the container stored on said attached tag or obtaining the digital representation of the container based on the information stored on said attached tag, and
providing the obtained digital representation of the container to the computer processor via the communication interface.

In one example, the identification tag is attached to the container permanently. In this case, the tag must be able to withstand the cleaning conditions used prior to refilling the container. Use of a permanently attached identification tag renders detaching the tag prior to cleaning and reattaching the tag after the cleaning process superfluous. In another example, the identification tag is detachable such that it can be removed prior to the cleaning process and can be attached to the container after the cleaning process. Detachment prior to cleaning reduces the risk of damaging the tag during the cleaning process, thus guaranteeing that the digital representation can be provided to the processor without any incidents.

The identification tag may be an RFID tag. With preference, the identification tag is an NFC tag, in particular a passive NFC tag. Use of a passive NFC tag allows to perform the inventive method in explosion protected areas.

The digital representation of the container stored on the identification tag may be retrieved by means of the sensor device. This allows to quickly provide the digital representation to the computer processor used for determining the fill level without requiring a further device, such as a further scanning device.

In one example, the digital representation of the container is stored on the tag. In this case, the said digital representation may be retrieved with the sensor device when the sensor device is in close proximation of the identification tag, for example after coupling of the sensor device to the container.

In another example, the digital representation of the container is obtained based on the information stored on the tag. Information stored on the tag may include, for example, the ID of the container. Obtaining the digital representation of the container based on the information stored on said attached tag may include retrieving the information stored on said attached tag by means of the sensor device and obtaining the digital representation of the container from a data storage medium, in particular a database, based on the retrieved information stored on the attached tag. This is preferred because it allows to update the digital representation easily without having to change the information stored on the identification tag. The data storage medium may contain a database which contains the digital representation of the container associated with the ID of the container stored on the tag. The data storage medium may be present within the sensor device or may be present in another device, such as a further computing device. In case the data storage medium may be present in another device, the sensor device may retrieve the digital representation of the container stored on the data storage medium being present in a further device via a communication interface.

The obtained digital representation may be stored on a data storage medium, in particular a data storage medium being present in the sensor device, prior to providing said digital representation to the computer processor via the communication interface for further processing. In this case, the sensor device functions as a cache and guarantees that the retrieved digital representation is provided to the computer processor even if the connection between the sensor device and the computer processor via the communication interface is temporarily interrupted.

The digital representation of the container may be provided to the computer processor upon predefined time points or the provision may be initiated upon predefined events, for example, upon updating of the digital representation of the container or prior to determining the fill level of the liquid in the container. This procedure guarantees that all available information associated with the container can be used for processing.

In step (iii), the container is acoustically stimulated by means of the sensor device to generate at least one audio signal being indicative of the fill level of the liquid in the container. In an aspect, the sensor device comprises an actuator, at least one microphone, a computer processor, in particular a microprocessor, a data storage medium, at least one further sensor that detects at least one property of the container other than the fill level of the liquid in the container and at least one power supply. “Microprocessor” refers to a semiconductor chip that contain a processor as well as peripheral functions. In many cases, the working and program memory is also located partially or completely on the same chip. With particular preference, the sensor device is powered by at least one battery commonly used in the industry. Use of at least one battery to power the sensor device renders an external power supply of the sensor device superfluous and allows easy detachment of the sensor device to the container. To reduce maintenance efforts associated with the sensor device, the battery/batteries should have a battery life of at least 3 years. To prevent damage of the sensor device after physical coupling to the container, the components of the sensor device may be present inside a housing which may be designed to be physically robust for outdoor use. The housing may be made of plastic, should be free of silicones and should be easily cleanable. With particular preference, the sensor device should be ATEX compliant such that it can be used in combination with containers located in areas requiring special measures concerning explosion protection. At least part of the components of the sensor device may be integrated together, for example, on a printed circuit board (PCB).

The actuator may be a solenoid or a vibration generator, in particular a vibration generator.

In one example, the sensor device comprises exactly one microphone. In another example, the sensor device may comprise at least 2 microphones. Use of at least 2 microphones may reduce the amount of interfering noises detected by the microphones. The at least one microphone may be a capacitive microphone or a micro electromechanical system (MEMS) microphone, in particular a micro electro machinal system (MEMS) microphone. MEMS microphones are comparatively small and need relatively low amounts of energy, thus allowing a compact design the sensor device and increased battery life of the batteries present inside the sensor device. With particular preference, the MEMS microphone(s) are directed and soundproofed in order to reduce unwanted interferences.

The at least one further sensor may be a climate sensor, a movement sensor, an ambient light sensor, a position sensor, a sensor detecting the power supply level or a combination thereof. The climate sensor may be configured to measure any of a variety or climate conditions of the sensor device, e.g., inside the housing of the sensor device or climate conditions surrounding the sensor device. Such climate conditions may include temperature, air humidity, air pressure, other climate conditions or any suitable combination thereof. Climate conditions surrounding the sensor device may, for example, be determined by a climate pressure equalization gasket present in the sensor device. The movement sensor, such as an accelerometer or gyrometric incremental motion encoder (IME), maybe be configured to detect and measure two- or three-dimensional (e.g., relative to two or three axes) movement. That is, the movement sensor may be configured to detect relative abrupt movement, e.g., as a result of a sudden acceleration, in contrast to a more general change in geographic location which is preferably detected by the position sensor. Such a movement may occur, e.g., as a result of the container being moved from the transport vehicle, transported for emptying, movements during transportation, etc. The movement sensor may be used to transition the sensor device from a sleep mode to an active mode or vice versa as described hereinafter. Use of a sleep mode may increase the battery life of the batteries used to power the sensor device, thus prolonging the maintenance intervals of the sensor device. For example, the processor of the sensor device may have an interrupt functionality to implement an active mode of the sensor device upon detection of movement by the movement sensor or a sleep mode in the absence of a detection of movement by the movement sensor for a defined period. The position sensor is used to determine the location of the container having attached thereto the sensor device, and may include WiFi technology, ISM technology, global satellite navigation system technology or a combination thereof. The position sensor may be switched on upon detection of a movement by the movement sensor or may be programmed to determine the position at pre-defined time points, for example by initiating a WiFi connection of the sensor device with a WiFi device in the neighbourhood of the sensor device and/or determining the position of the sensor device using a global navigation satellite system. The ambient light sensor may serve to ensure the integrity of the housing and/or electronics, including providing mechanical dust and water detection. The sensor may enable detection of evidence of tampering and potential damage, and thus provide damage control to protect electronics of the sensor device.

In one example, the sensor device may further comprise a display such that determined fill level(s) and/or data acquired by further sensors and/or the battery level may be displayed. In another example, the sensor device may not comprise a display to reduce the complexity of the device and to comply with ATEX regulations. In this case, the determined fill level and further sensor data and/or battery level is provided via a communication interface to a further device for display.

In an aspect, acoustically stimulating the container to generate at least one audio signal being indicative of the fill level of the liquid in the container includes beating on the outer wall of the container by means of the actuator of the sensor device to induce the at least one audio signal. The beating energy is not critical and may be chosen such that the energy necessary to obtain sufficient acoustic stimulation of the container and the battery life of the sensor device are balanced. Moreover, the beating energy may dependent on regulations, such as regulations for explosion protected areas. In one example, the beating is performed with an energy of up to 3.4 newton meter, preferably with 0.3 to 0.7 newton meter, in particular with 0.5 newton meter. An energy of up to 3.4 newton meter is preferable if the sensor device is operated in explosion protected areas. In another example, the beating energy is higher than 3.4 newton meter. This may be preferably if the sensor device is not operated in explosion protected areas and a high beating energy is necessary to provide sufficient acoustic stimulation of the container. The sensor device may be configured to perform the beating at a predefined rate (e.g., a beating frequency), e.g., once every x hour(s), once every x minute(s), once every x second(s), less than a second, etc., and the beating frequency may be different for different times of day, or days of a week, month or year. With particular preference, the beating may be performed at time points, when background noises, such as noises arising from stirring the liquids in the container, moving the container, actions performed in the surrounding of the container, are absent or at a minimum level to increase accuracy of the determination of the fill level of the liquid in the container. For this purpose, beating may be performed at predefined time points with minimum background noises, for example during the night or a defined time period after partial removal of the liquid from the container.

In an aspect, step (iii) may further include—prior to or after acoustic stimulation of the container—detecting at least one further property of the container other than the fill level, in particular the position of the container and/or the temperature and/or the battery level of the sensor device, with at least one sensor of the sensor device.

Detecting of the further property may either be initiated upon detection of movement, for example by the movement sensor, may be triggered by acoustic stimulation of the container by the sensor device or may be performed upon pre-defined time points. In one example, determining a change in position—which may have been triggered by detecting a movement with the movement sensor—may result in triggering the acoustic stimulation of the container. For example, the sensor device may have stored in the internal memory predefined locations of emptying stations and storage locations and may, upon detecting movement of the container from the emptying station, initiate determination of the position as previously described. In case the determined container position is matching the stored information on the storage location, the sensor device may be programmed to initiate acoustic stimulation of the container to determine the fill level of the liquid remaining after return of the container from the emptying station to the storage station. In another example, triggering of the acoustic stimulation may be performed after it has been determined with the processor of the sensor device that that battery level is above a predefined threshold to guarantee that sufficient power for acoustic stimulation and detection/processing of generated audio signal(s) is available. In yet another example, triggering of the acoustic stimulation may depend on whether the temperature determined with the temperature sensor is below or above a predefined value.

In step (iv), the generated audio signal(s) are detected and optionally processed. In an aspect, the at least one generated audio signal is detected with the at least one microphone of the sensor device. If the sensor device contains more than one microphone, at least one microphone of the sensor device is used to detect the generated audio signal(s). In one example, all microphones of the sensor device are used to detect the generated audio signal(s). In another example, only part of the microphones of the sensor device are used to detect the generated audio signal(s) while the remaining microphone(s) of the sensor device are used to detect ambient or background noises. The detected ambient or background noises may then be used during processing of the detected audio signal to subtract the background or ambient noises from the detected audio signal(s).

In an aspect, the audio signal is detected 0.1 to 1 second, in particular 0.3 to 0.5 seconds, after acoustical stimulation of the container by means of the sensor device. Time-shifted detection of the audio signal(s) after acoustical stimulation of the container by means of the sensor device may be beneficial because all frequencies are equally stimulated directly after the acoustical stimulation while the audio signal(s) being indicative of the filling level are generated time-shifted with respect to the acoustical stimulation.

In an aspect, the audio signal is detected for a duration of up to 2 seconds, in particular of up to 1.6 seconds, after acoustical stimulation of the container by means of the sensor device. Since the damping of the audio signal is rather strong, it may be beneficial to detect the audio signal(s) for a limited period of time to save energy and prolong the battery lifetime of the batteries present in the sensor device.

In an aspect, processing the detected audio signal(s) includes digitally sampling—with the computer processor—the audio signal(s) detected by the at least one microphone of the sensor device as a result of the acoustic stimulation of the container. Digital sampling with the computer processor may be performed using pulse-code-modulation (PCM) or pulse-density-modulation (PDM). Pulse-code modulation (PCM) is a method used to digitally represent sampled analog audio signals. In a PCM stream, the amplitude of the analog signal is sampled regularly at uniform intervals, and each sample is quantized to the nearest value within a range of digital steps. In one example, the sampling frequency used for PCM is 16 kHz. Pulse-density modulation (PDM), is a form of modulation used to represent an analog audio signal with a binary signal. In a PDM signal, specific amplitude values are not encoded into codewords of pulses of different weight as they would be in pulse-code modulation (PCM); rather, the relative density of the pulses corresponds to the analog signal's amplitude. The output of a 1-bit DAC (digital to analog converter) is the same as the PDM encoding of the signal.

The audio samples may be further processed—with the computer processor—by calculating a Fourier spectrum of the detected audio sample(s), optionally extracting at least one predefined feature from the calculated Fourier spectrum, and optionally combining the extracted features. Prior to calculating a Fourier spectrum, the detected audio sample(s) may be aligned, and the Fourier spectrum may be calculated from the aligned audio sample(s). Aligning the audio samples may include detecting the onset of the acoustic stimulation of the container arising from beating on the outside of the container with the actuator. The onset may be determined by thresholding algorithms, such as adaptive threshold algorithms, and the audio samples may then be aligned to the detected onset. Alignment of the audio sample(s) ensures that signal(s) being indicative of the fill level are obtained independent of the measurement situation such that the temporal course of the detected signal(s)—which is indicative of the fill level—is comparable. The Fourier spectrum is calculated (also called spectrogram hereinafter) by using short-time Fourier transformation (also called STFT) from the detected or aligned audio sample(s), in particular from the aligned audio sample(s). The STFT represents a signal in the time-frequency domain by computing discrete Fourier transforms (DFT) over short overlapping windows. The length of the audio frames of the audio signal(s) used for calculation of the Fourier spectrum may be at least 5 ms and at most 3 seconds. In one example, the STFT is performed by splitting the detected or aligned audio sample(s) into a set of overlapping windows according to a predefined size, creating frames out of the windows and performing DFT on each frame. Suitable predefined sizes include a range of 2 to 4096, such as 2, 4, 8, 16, 64, 128, 1024, 2084 or 4096. The result is a matrix of complex numbers where each row represents an overlapping window with magnitude and phase of frequency. Prior to extracting at least one predefined feature as described in the following, the magnitude (or modulus) r of the complex numbers z=x+yl (where x is the real part and y is the imaginary part) may be calculated according to r=|z|=\sqrt{x²+y²}. This allows to obtain the magnitudes of the frequency and the phases of the frequency and to use the result of the STFT or the predefined features extracted from said STFT result in combination with a data-driven model selected from ensemble algorithms, such as gradient boosting machines (GBM) or gradient boosting regression trees (GBRT) described later on.

The predefined features can then be computed for each audio frame using the spectrogram or the calculated magnitudes of frequency and phases of frequency. “Predefined features” may refer to features being indicative of the fill level, and may include: frequency with the highest energy, (normalized) average frequency, (normalized) median frequency, the standard deviation of the frequency distribution, the skew of the frequency distribution, deviation of the frequency distribution from the average or median frequency in different LP spaces, spectral flatness, (normalized) root-mean-square, fill-level specific audio coefficients, fundamental frequency computed by the yin algorithm, (normalized) spectral flux between two consecutive frames and any combinations thereof. The spectral flatness may be calculated from the spectrogram as disclosed in S. Dubnov, “Generalization of spectral flatness measure for non-Gaussian linear processes”; IEEE Signal Processing Letters; vol. 11, pages 698 to 701, 2004. The fill-level specific audio coefficients may be obtained by the following steps:
scaling the amplitudes of the spectrogram by a function that weights fill-level and container-specific frequencies higher than other frequencies. Such function can be obtained by simulation or experimentally, for example as described in Jeong et al. “Hydroelastic vibration of a liquid-filled circular cylindrical shell.” Computers & structures, Vol 66.2-3, 1998, pages 173-185.
computing the log-power spectrum from the scaled amplitudes and
calculating the discrete cosine transform of the log-power spectrum and using the amplitudes of the discrete cosine transform as fill-level specific audio coefficients

The predefined features may be calculated from the spectrogram for each audio frame or the calculated magnitudes of frequency and phases of frequency or in the log-power domain using commonly known methods.

The predefined features may be used to perform anomaly detection to filter out corrupt audio samples, such as audio samples recorded during movement of container or liquid inside the container, or audio samples having a high background noise, to improve accuracy of the fill level determination. For this purpose, trained algorithms, such as SVM-machines, autoencoders, isolation forests, LSTM-, GRU- or transformer-classifiers may be used. The training is performed using labelled training data comprising features being extracted from corrupt and non-corrupt audio samples. In case an anomaly is detected, step (iii) may be repeated after a predefined time period, for example by providing a respective instruction to the processor of the sensor device. In one example, the extracted features are combined by reducing the dimensionality of the predefined features using algorithms, such as the principal component analysis (PCA), known in the state of the art since calculation of the previously described features may result in data being too large for machine learning. In particular, the number of features may be reduced to less than 50 prior to performing machine learning. As combined features, the components of the PCA having the highest eigenvalues may be used. In another example, the predefined features are combined by aggregation of the extracted features. If machine learning algorithms other than deep learning based classification algorithms, such as convolutional neural networks (CNNs) and recurrent neural networks (RNNs), are used, extraction and combination of predefined features result in an improved accuracy of the determination of the fill level using the data driven model and the digital representation of the container, especially in borderline cases between the container being empty and the container still comprising liquid. Therefore, the extraction of predefined features and combination of the extracted predefined features is preferred if machine learning algorithms other than deep learning-based classification algorithms are used. If deep learning based classification algorithms, such as convolutional neural networks (CNNs) and recurrent neural networks (RNNs), are used, the calculated spectrograms can be used for fill level determination without performing the previously described feature analysis because said algorithms result in the required accuracy without performing the feature extraction and combination.

In one example, processing of the detected audio signal(s) is performed using the computer processor of the sensor device. This may be preferred if the computing power of the processor is high enough to allow reasonable processing times without consuming high amounts of energy that would significantly reduce the battery life of the battery/batteries present in the sensor module. Reasonable processing times with respect to energy consumption may be, for example, up some 10 seconds.

In another example, processing of the detected audio signal(s) is performed using a computer processor being different from the computer processor of the sensor device. The computer processor being different from the computer processor of the sensor device can be located on a server, such that processing of the detected audio signals is performed in a cloud computing environment. In this case, the sensor device functions as client device and is connected to the server via a network, such as the Internet or a mobile communication. The server may be accessed via a mobile communication technology. The mobile communication-based system is in particular useful, if the computing power of the sensor device is not high enough to perform processing of the detected audio signals in a reasonable time or if processing of the audio signals by the sensor device would reduce the battery life of the battery/batteries of the sensor device unacceptably.

In an aspect, step (iv) further includes storing the detected or processed audio signal(s) on a data storage medium prior to providing the detected or processed audio signal(s) to the computer processor via the communication interface. Storing the detected or processed audio signal(s) prevents data loss in case the communication to the computer processor via the communication interface is interrupted for a certain time period or is interrupted during providing the data via the communication interface to the computer processor. In this case, the stored detected or processed audio signal(s) can be retransmitted after the interruption has been eliminated. The data storage medium may either be present inside the sensor device or may be present in a further computing device being separate from the sensor device, such as described previously.

In case at least one further property has been detected in step (iii), step (iv) may further include providing the detected at least one further property of the container other than the fill level, in particular the position of the container and/or the temperature and/or the battery level of the sensor device, to the computer processor via the communication interface. Prior to providing the detected property, it may be beneficial to store the acquired sensor data on a data storage medium as previously described.

In an aspect, steps (iii) and (iv) are repeated at least once, preferably between 2 and 10 times, in particular 5 times. Repetition of steps (iii) to (iv) increases the accuracy of the determination of the fill level. Therefore, it may be preferable to repeat steps (iii) and (iv) at least once to increase the accuracy of the determination of the fill level of the liquid inside the container. However, numerous repetitions also decrease the battery life of the battery/batteries of the sensor device without significantly increasing the accuracy of the determination any further. Thus, is particularly preferred to repeat steps (iii) to (iv) 5 times to increase the accuracy of the determination without unduly reducing the battery life of the battery/batteries present inside the sensor device.

In step (v), the detected or processed audio signal(s) being indicative of the fill level of the liquid in the container are provided to the computer processor via a communication interface. The communication interface may be wireless or wired, in particular a wireless, as previously described.

In step (vi), at least one data driven model parametrized on historical audio signals, historical fill levels of liquids and historical digital representations of containers is provided to the computer processor via the communication interface. The data-driven model provides a relationship between the fill level of the liquid in the container and the detected or processed audio signal(s) and is derived from historical audio signal(s), historical fill levels of liquids in containers and historical digital representations of the containers. The historical digital representations of the containers preferably comprise data on the size of the container, in particular data on the filling volume of the container, data on the content of the container, data on the initial filing level, data on the age of the container, data on the use cycle of the container and any combination thereof.

In an aspect, step (vi) includes providing at least two data driven models to the computer processor via the communication interface. This may further include selecting—with the computer processor—a data driven model from the provided data driven models based on the provided digital representation of the container, in particular based on the provided filling volume of the container. Use of a data driven model being specific for the filling volume of the container allows to increase the accuracy of the determination of the fill level of the liquid in the container by selecting the data driven model providing the highest accuracy of the determination. In one example, a plurality of data driven models may exist for the provided filing volume. In this case, either one data-driven model may be selected, or the filing volume may be determined using a part or all of the available models and the results may be stacked as described below to improve accuracy.

In an aspect, each data driven model is derived from a trained machine learning algorithm. “Machine Learning” may refer to computer algorithms that improve through experience and build on a model based on sample data, often described as training data, utilizing supervised, unsupervised, or semi-supervised machine learning techniques. Supervised learning includes using training data having a known label or result and preparing a model through a training process in which it is required to make predictions and is corrected when those predictions are wrong. The training process continues until the model achieves a desired level of accuracy on the training data. Semi-supervised learning includes using a mixture of labelled and unlabelled input data and preparing a model through a training process in which the model must learn the structures to organize the data as well as make predictions. Unsupervised learning includes using unlabelled input data not having a known result and preparing a model by deducing structures, such as general rules, similarity, etc., present in the input data. In one example, the machine learning algorithm is trained by selecting inputs and outputs to define an internal structure of the machine learning algorithm, applying a collection of input and output data samples to train the machine learning algorithm, verifying the accuracy of the machine learning algorithm by applying input data samples of known fill levels and comparing the produced output values with expected output values, and modifying the parameters of the machine learning algorithm using an optimizing algorithm in case the received output values are not corresponding to the known fill levels. As inputs, the previously described spectrograms obtained by Fourier transformation of the detected or aligned audio sample(s) or the combined predefined features obtained as previously described may be used, optionally in combination with data acquired by further sensors of the sensor device. The input data is selected randomly but with the proviso that the training data contains the complete spectra of filling levels. Output may either be a classifier, such as “empty” or “not empty” or the exact filing level, for example in % with respect to the starting filling level. In principle, a suitable machine learning model or algorithm can be chosen by the person skilled in the art considering the pre-processing, the existence of a solution set, the distinction between regression and classification problems, the computational load, and other factors. The machine learning algorithms cheat sheet may be used for this purpose (see FIG. 6 in P. Sivasothy et al.: “Proof of concept: Machine learning based filling level estimation for bulk solid silos”; Proc. Mtgs. Acoust.; Vol. 35; 055002; 2018). In case the fill level should be predicted exactly, regression algorithms need to be chosen, while classification algorithms may be used in case the fill level should be a classifier, such as “empty” or “not empty”. Within the present invention, the machine learning algorithms may be (i) deep learning algorithms, such as Long Short-Term Memory (LSTM) algorithms, Gated Recurrent Unit (GRU) algorithms or perceptron algorithms, (ii) instance-based algorithms, such as support vector machines (SVMs), (iii) regression algorithms, such as linear regression algorithms, or (iv) ensemble algorithms, such as gradient boosting machines (GBM), gradient boosting regression trees (GBRT), random forests or a combination thereof, in particular ensemble algorithms. “Deep learning” may refer to methods based on artificial neural networks (ANNs) having an unbounded number of layers of bounded size, which permits practical application and optimized implementation, while retaining theoretical universality under mild conditions. Deep learning architectures implementing deep learning algorithms may include deep neural networks, deep belief networks (DBNs), recurrent neural networks (RNNs) and convolutional neural networks (CNNs). In Ensemble Learning, an ensemble (collective of predictors) is formed to produce an ensemble average (collective mean). The predictors can be identical algorithms having different parameters, such as several k nearest neighbour classifiers having different k values and dimension weights, or can be different algorithms which are all trained on the same problem. In prediction, either all classifiers are treated equally or weighted differently. According to an ensemble rule, the results of all classifiers are aggregated, in case of classification by a majority decision, in case of regression mostly by averaging or (in case of stacking) by another regressor. Combination of the algorithms in the ensemble may be performed by the following kinds of meta algorithms: bagging, boosting, or stacking. Bagging considers homogeneous weak learners (i.e. the same algorithm), learns them independently from each other in parallel and combines them following some kind of deterministic averaging process. In one example, the training data set is either fully divided, i.e. the complete training data set is divided and used for training, or only randomly used, i.e. some data is used multiple times, while other data is not used at all. In another example (also called pasting), the data splitting must not overlap. Accordingly, each classifier is trained with specific training data, i.e. is trained independently from the other classifiers. Boosting often considers homogeneous weak learners, learns them sequentially in a very adaptative way (i.e. the weights are adjusted during multiple runs) and combines them following a deterministic strategy. The weights may be adjusted in the direction of the prediction error, i.e. incorrectly predicted data sets are weighted higher in the next run, or in the opposite direction of the prediction error (also known as gradient boosting). Suitable optimization algorithms to manipulate the parameters of the learning algorithm(s) during training are known in the state of the art and include, for example, gradient descent, momentum, rmsprop, newton-based optimizers, adam, BFGS or model specific methods. These optimizing algorithms are used during training of the machine learning algorithm to modify the parameters in each training step such that the difference between the output of the machine learning algorithm and the expected output is decreased until a predefined termination criterium, such as number of iterations or accuracy, is obtained.

In step (vii), the fill level of the liquid in the container is determined with the computer processor based on the provided digital representation of the container, the provided audio signal(s) and the provided data driven model(s). In one example, the classifiers or regressors from different algorithms and audio samples are stacked to obtain a higher accuracy. Stacking is an extension of an ensemble learning algorithm by a higher level (blending level), which learns the best aggregation of the single results. At the top of stacking is (at least) one more classifier or regressor. Stacking is especially useful when the results of the individual algorithms vary greatly, which is almost always the case in regression since continuous values instead of a few classes are outputted. Suitable stacking algorithms are known in the state of the art and may be selected by the person skilled in the art based on his knowledge.

In an aspect, the detected at least one further property of the container other than the fill level, in particular the position of the container and/or the temperature, is considered during determination of the fill level of the liquid in the container.

In an aspect, the fill level of the liquid in the container is determined in step (vii) with the computer processor of the sensor device. This may be preferred if the computing power of the sensor device is sufficiently high to determine the fill level of the liquid in the container using the data driven model, the provided digital representation of the container and the provided detected or processed audio signal(s) within a reasonable time, i.e. up to some 10 seconds, without consuming large amounts of energy

In an alternative aspect, the fill level of the liquid in the container is determined in step (vii) with a computer processor being different from the computer processor of the sensor device. In one example, the computer processor being different from the computer processor of the sensor device can be located on a server, such that processing of the detected audio signals is performed in a cloud computing environment as previously described. In another example, the computer processor being different from the computer processor of the sensor device This is particularly preferred if the computing power of the computer processor of the sensor device is insufficient to determine the fill level of the liquid in the container within a reasonable time or if the use of the computer processor of the sensor device to determine the fill level of the liquid in the container would be associated with significant power consumption, thus significantly reducing the battery life of the battery/batteries of the sensor device and thus increasing the maintenance intervals for the sensor device. The detected or processed audio signal and the digital representation of the container may be provided to the computer processor of the further computing device via a wireless telecommunication wide area network protocol, in particular a low-power wide-area network protocol prior to the determination performed in step (vii). Use of a low-power wide area network protocol results in low energy consumption and thus increases the battery lifetime of the batteries of the sensor device and therefore also the maintenance intervals associated with the battery exchange.

In step (viii) the determined fill level of the liquid in the container is provided via the communication interface. In an aspect, the step of providing via the communication interface the determined fill level of the liquid in the container includes transforming the determined fill level into a numerical variable or a descriptive output, each being indicative of the fill level of the liquid in the container prior to providing the determined fill level of the liquid in the container via the communication interface. The numerical variable could be a single continuous variable that may assume any value between two endpoints. An example being the set of real numbers between 0 and 1. As a further example, the numerical variable could consider the uncertainty inherent in the data, for example in the detected or processed audio signal(s) and the output of the data driven model. An example being the range from 0 to 1, with a 1 indicating no uncertainty in the result. The output could also be transformed into a descriptive output indicative of the fill level of the liquid. In particular, the descriptive output could include an empty/not empty format or a %-value based on the original filling volume.

In an aspect, providing the determined fill level of the liquid in the container via the communication interface includes displaying the determined fill level of the liquid of the container on the screen of a display device. The display device may comprise a GUI to increase user comfort. In addition to the determined fill level, the display device may also display data used to determine the displayed fill level, such as data contained in the digital representation, data associated with processing of the audio signal(s), the data driven model used for the determination, data acquired by further sensors, the time of acoustic stimulation and any combination thereof.

In an aspect, providing the determined fill level of the liquid in the container via the communication interface includes storing the provided fill level of the liquid in the container on a data storage medium, in particular in a database. Storing the determined fill level(s) on a data storage medium allows to generate data which can be used to optimize the repetition of steps (iii) and (iv) by analyzing the frequency of the measurement and the associated fill levels. Moreover, this data can be used for prediction purposes, for example for predicting the time point when the container will be empty, when maintenance intervals may be scheduled etc.

In an aspect, repeating steps (iii), (iv), (v), (vii) and optionally step (viii) are repeated. In one example, repeating the aforementioned steps may be triggered by a routine executed by the computer processor at predefined time points. This allows to perform the aforementioned steps under ideal measurement conditions, i.e. recued background noises. In another example, repetition may be triggered by retrieving the digital representation of the container with the sensor device. As previously described, the container may comprise an identification tag storing information, such as a container ID, which can be used by the sensor device to retrieve the digital representation of the container from a database. The digital representation may contain information on the date and/or time of withdrawal of liquid from the container and may be used to trigger the aforementioned steps. In yet another example, the aforementioned steps may be triggered by the movement sensor detecting a movement or by absence of a movement detection. In yet another example, the aforementioned steps may be triggered by a change in location or by determining a predefined location. Triggering of the repetition upon predefined time points or predefined conditions allows to reduce the number of measurements and therefore also the power consumption of the sensor device, thus prolonging the battery lifetime of the battery/batteries of the sensor device. Triggering also guarantees that the time span between two measurements is small enough so that containers being empty and ready for pick up for cleaning and refilling are detected quickly, thus reducing the idle time of empty containers and therefore increasing the efficiency of the lifecycle of containers.

In an aspect, the method further includes the step of determining an action to be taken for the container based on the provided fill level of the liquid in the container and the provided digital representation and optionally controlling taking the determined action. In one example, the action may be determined and controlled by the computer processor of the sensor device in accordance with programmed routines. In another example, the action may be determined by the computer processor of the sensor device and controlled by a further computer processor being present separate from the sensor device, for example in a further processing device. For this purpose, the sensor device may forward the determined action via a communication interface to the further computer processor. In yet another example, the action may be determined and controlled by a further computer processor as previously mentioned based on the provided fill level of the liquid in the container and the digital representation. In determining the action, the computer processor may consider—apart from the determined/provided fill level and digital representation—sensor data gathered by further sensors of the sensor device, such as movement data, climate data, location data and combinations thereof. Actions may be predefined and may differ for different states/locations of the containers, the time of day, day or week, month or year, parameter values received from a container management network, user input, other conditions, or a suitable combination thereof. Actions may include, for example: scheduling transport, cleaning, emptying, filling, movement, discarding or maintenance of the container, ordering of new container(s), changing the location of the container, powering down, powering up or adjusting behavior of the sensor device, activating an alarm (e.g., a visual, sound or noise), other actions, or any suitable combination of the foregoing. It should be appreciated that different actions may be taken for the same determined property based on the current state/location and/or other conditions as previously described.

In an aspect, the method further includes determining—with the computer processor—an optimized maintenance interval based on the provided fill levels of the liquids in the container and the provided digital representation of the container. Data on the provided fill levels can be associated with the digital representation of the container and can be used to predict the time point when the container will be empty and can be transported back for maintenance. This prediction thus allows to schedule maintenance intervals for containers still being in use without having to wait until the container has been transported back, thus allowing to optimize the maintenance intervals based on the predictions.

In an aspect, the method further includes the step of determining—with the computer processor—consolidated transports of empty containers based on the provided fill levels of the liquids in the containers and the provided digital representations of the containers. Calculation of consolidated transports based on determined fill levels of containers to reduce emissions and transportation costs is well known in the state of the art (see for example: J. Ferrer et al.; “BIN-CT: Urban waste collection based on predicting the container fill level”; BioSystems; Vol. 186; 2019; 103962).

In summary, the determined fill level along with further sensor data gathered by the sensor device and the digital representation of the container can be used to manage the lifecycle of containers in an efficient and reliable way. The method may be used for vendor-managed inventory (VMI) (also known as supplier-controlled inventory or supplier-managed inventory (SMI)) which is a logistics means of improving supply chain performance because the supplier has access to the customer's inventory and demand data.

Embodiments of the Inventive Container:

In an aspect, the container comprises a sensor device, in particular a sensor device for generating, detecting, and optionally processing at least one audio signal being indicative of the fill level of the liquid in the container. The sensor device is preferably a sensor device as described in relation to the inventive method.

Embodiments of the Inventive System:

The sensor device as described herein may be considered a kind of internet-of-things (IoT) device which may be communicatively coupled to a further computing device, such as remotely located server(s), which may be accessed by clients. The system of the invention can therefore be operated as a container management network as described in relation to FIG. 9 below.

In an aspect, the computer processor (CP) is located on a server, in particular a cloud server. In this case, the fill level of the liquid in the container is determined by a computer processor located on a server based on the audio signal(s) generated by the sensor device and being indicative of the fill level.

In an alternative aspect, the computer processor (CP) is corresponding to the processor of the sensor device. In this case, the fill level of the liquid in the container is determined by the computer processor of the sensor device based on audio signal(s) generated by the sensor device and being indicative of the fill level.

In an aspect, the sensor device is permanently attached to the container or is detachable, in particular detachable. Detachable configuration of the sensor device prevents recertification of the container as previously mentioned and thus allows to attach the sensor device without any extensive certification processes to existing containers which already have been certificated. Moreover, detachable configuration allows to easily remove the sensor device prior to the cleaning process, thus preventing destruction of the device during said cleaning.

The sensor device may be physically coupled to the outside of the container by means of a bar. The bar may be detachably attached to the container, for example by clamping the bar into the frame surrounding the container. This avoids permanent modification of the container which gives rise the recertification and thus allows to use the sensor device in combination with existing containers without having to recertificate each container having the bar and optionally sensor device attached.

The bar may comprise an identification tag, preferably an RFID tag, in particular a passive NFC tag, being configured to provide the digital representation of the container or information being associated with the digital representation of the container via a communication interface to the computer processor (CP). Upon attaching the sensor device on the bar, the sensor device may initiate a coupling procedure to retrieve the digital representation of the container stored on the tag or information associated with the digital representation of the container stored on the tag.

Embodiments of the Client Device:

The server device may comprise at least one data storage medium containing at least one data driven model, said model(s) being used for determining the fill level of the liquid in the container.

Further embodiments or aspects are set forth in the following numbered clauses:
1. A method for determining the fill level of a liquid in a container, said method comprising the steps of:
   (i) attaching a sensor device to the container,
   (ii) providing to a computer processor via a communication interface a digital representation of the container;
   (iii) acoustically stimulating the container by means of the sensor device to generate at least one audio signal being indicative of the fill level of the liquid in the container,
   (iv) detecting the generated audio signal(s) and optionally processing the detected audio signal(s);
   (v) providing to the computer processor via the communication interface the detected or processed audio signal(s) being indicative of the fill level of the liquid in the container;
   (vi) providing to the computer processor via the communication interface at least one data driven model parametrized on historical audio signals, historical fill levels of liquids in containers and historical digital representations of the containers,
   (vii) determining, with the computer processor, the fill level of the liquid in the container based on the provided digital representation of the container, the provided audio signal(s) and the provided data driven model(s); and
   (viii) providing via the communication interface the determined fill level of the liquid in the container.
2. The method according to clause 1, wherein the liquid is a chemical composition, in particular a liquid coating composition or components of a liquid coating composition.
3. The method according to clause 1 or 2, wherein the container is a plastic, glass, or metal container, preferably a metal intermediate bulk container (IBC) optionally comprising a plastic inliner, in particular a single walled stainless-steel or aluminium intermediate bulk container (IBC).
4. The method according to any one of the preceding clauses, wherein the fill level of the liquid in the container is a classifier corresponding to the container being empty or the container not being empty.
5. The method according to any one of the preceding clauses, wherein the sensor device is permanently or detachably physically coupled to the outside of the container, in particular detachably physically coupled to the outside of the container.
6. The method according to any one of the preceding clauses, wherein the digital representation of the container comprises data on the size of the container, in particular data on the filling volume of the container, data on the content of the container, data on the initial filing level, filing date, data on the location of the container, data on the age of the container, data on the use cycle of the container, data on the maintenance intervals of the container, data on the maximum life time of the container, expiry date of container content, and any combination thereof.
7. The method according to clause 6, wherein data on the location of the container is obtained by locating the position of the container by means of the sensor device via a wireless communication interface, in particular WiFi, and/or via a satellite-based positioning system, in particular a global navigation satellite system.
8. The method according to any one of the preceding clauses, wherein the step of providing the digital representation of the container includes
   attaching an identification tag to the container,
   retrieving the digital representation of the container stored on said attached tag or obtaining the digital representation of the container based on the information stored on said attached tag, and
   providing the obtained digital representation of the container to the computer processor via the communication interface.
9. The method according to clause 7, wherein the identification tag is permanently attached to the container or is detachable.
10. The method according to clause 7 or 8, wherein the identification tag is an RFID tag, preferably an NFC tag, in particular a passive NFC tag.
11. The method according to any one of clauses 7 to 9, wherein the digital representation of the container stored on the identification tag is retrieved by means of the sensor device.
12. The method according to any one of clauses 7 to 10, wherein the step of obtaining the digital representation of the container based on the information stored on said attached tag is further defined as retrieving the information stored on said attached tag by means of the sensor device and obtaining the digital representation of the container from a data storage medium, in particular a database, based on the retrieved information stored on the attached tag.
13. The method according to any one of clauses 7 to 11, wherein the obtained digital representation is stored on a data storage medium, in particular a data storage medium being present in the sensor device, prior to providing said digital representation to the computer processor via the communication interface.
14. The method according to any one of the preceding clauses, wherein the sensor device comprises an actuator, at least one microphone, a computer processor, in particular a microprocessor, a data storage medium, at least one further sensor that detects at least one property of the container other than the fill level of the liquid in the container and at least one power supply.
15. The method according to clause 14, wherein the actuator is a solenoid or a vibration generator, in particular a vibration generator.
16. The method according to clause 14 or 15, wherein the at least one microphone is a capacitive microphone or a micro electromechanical system (MEMS) microphone, in particular a micro electro machinal system (MEMS) microphone.
17. The method according to any one of clauses 14 to 16, wherein the at least one further sensor is a climate sensor, a movement sensor, an ambient light sensor, a position sensor, a sensor detecting the power supply level or a combination thereof.
18. The method according to any one of the preceding clauses, wherein acoustically stimulating the container to generate at least one audio signal being indicative of the fill level of the liquid in the container includes beating on the outer wall of the container by means of the actuator of the sensor device to induce the at least one audio signal.
19. The method according to clause 18, wherein the beating is performed with an energy of up to 3.4 newton meter, preferably with 0.3 to 0.7 newton meter, in particular with 0.5 newton meter.
20. The method according to any one of the preceding clauses, wherein the at least one generated audio signal is detected with the at least one microphone of the sensor device.
21. The method according to any one of the preceding clauses, wherein the audio signal is detected 0.1 to 1 second, in particular 0.3 to 0.5 seconds, after acoustical stimulation of the container by means of the sensor device.
22. The method according to any one of the preceding clauses, wherein the audio signal is detected for a duration of up to 2 seconds, in particular of up to 1.6 seconds, after acoustical stimulation of the container by means of the sensor device.
23. The method according to any one of the preceding clauses, wherein step (iii) further includes—prior to or after acoustic stimulation of the container—detecting at least one further property of the container other than the fill level, in particular the position of the container and/or the temperature and/or the battery level of the sensor device, with at least one sensor of the sensor device.
24. The method according to any one of the preceding clauses, wherein processing the detected audio signal(s) includes digitally sampling—with the computer processor—the audio signal(s) detected by the at least one microphone of the sensor device as a result of the acoustic stimulation of the container.
25. The method according to clause 23, wherein digital sampling is performed using pulse-code-modulation (PCM) or pulse-density-modulation (PDM).
26. The method according to clause 23 or 24, wherein the audio samples are further processed—with the computer processor—by optionally aligning the audio sample(s), calculating a Fourier spectrum of the detected or aligned audio sample(s), optionally extracting at least one predefined feature from the calculated Fourier spectrum and optionally combining the extracted features.
27. The method according to clause 26, wherein aligning the audio samples includes detecting the onset, in particular by thresholding algorithms, of the acoustic stimulation of the container arising from beating on the outside of the container with the actuator.
28. The method according to clause 26 or 27, wherein the Fourier spectrum is calculated using short-time Fourier transformation.
29. The method according to clause 28, wherein the magnitude r of the complex numbers contained in the matrix of complex numbers resulting from the short-time Fourier transformation is calculated.
30. The method according to any one of clauses 26 to 29, wherein the predefined features are selected from the frequency with the highest energy, the (normalized) average frequency, the (normalized) median frequency, the standard deviation of the frequency distribution, the skew of the frequency distribution, the deviation of the frequency distribution from the average or median frequency in different LP spaces, the spectral flatness, the (normalized) root-mean-square, fill-level specific audio coefficients, the fundamental frequency computed by the yin algorithm, the (normalized) spectral flux between two consecutive frames and any combinations thereof.
31. The method according to clause 30, wherein fill-level specific audio coefficients are obtained by the following steps:
   scaling the amplitudes of the spectrogram by a function that weights fill-level and container-specific frequencies higher than other frequencies. Such function can be obtained by simulation or experimentally.
   computing the log-power spectrum from the scaled amplitudes and
   calculating the discrete cosine transform of the log-power spectrum and using the amplitudes of the discrete cosine transform as fill-level specific audio coefficients.
32. The method according to any one of clauses 26 to 31, wherein combining the extracted predefined features includes reducing dimensionality of the extracted predefined features by means of algorithms, in particular by means of a principal component analysis (PCA).
33. The method according to any one of clauses 23 to 32, wherein processing of the detected audio signal(s) is performed using the computer processor of the sensor device.
34. The method according to any one of clauses 23 to 33, wherein processing of the detected audio signal(s) is performed using a computer processor being different from the computer processor of the sensor device.
35. The method according to any one of the preceding clauses, wherein step (iv) further includes storing the detected or processed audio signal(s) on a data storage medium prior to providing the detected or processed audio signal(s) to the computer processor via the communication interface.
36. The method according to any one of clauses 23 to 35, wherein step (iv) further includes providing the detected at least one further property of the container other than the fill level, in particular the position of the container and/or the temperature and/or the battery level of the sensor device, to the computer processor via the communication interface.
37. The method according to any one of the preceding clauses, wherein steps (iii) and (iv) are repeated at least once, preferably between 2 and 10 times, in particular 5 times.
38. The method according to any one of the preceding clauses, wherein step (vi) includes providing at least two data driven models to the computer processor via the communication interface.
39. The method according to clause 38, wherein step (vi) includes selecting—with the computer processor—a data driven model from the provided data driven models based on the provided digital representation of the container, in particular based on the provided filling volume of the container.
40. The method according to any one of the preceding clauses, wherein each data driven model is derived from a trained machine learning algorithm.
41. The method according to clause 40, wherein the machine learning algorithm is trained by selecting inputs and outputs to define an internal structure of the machine learning algorithm, applying a collection of input and output data samples to train the machine learning algorithm, verifying the accuracy of the machine learning algorithm by applying input data samples of known fill levels and comparing the produced output values with expected output values, and modifying the parameters of the machine learning algorithm using an optimizing algorithm in case the received output values are not corresponding to the known fill levels.
42. The method according to clause 40 or 41, wherein the machine learning algorithm is (i) a deep learning algorithm, such as a Long Short-Term Memory (LSTM) algorithm, or a Gated Recurrent Unit (GRU) algorithm, or a perceptron algorithm, (ii) an instance-based algorithm, such as a support vector machine (SVM), (iii) a regression algorithm, such as a linear regression algorithm, or (iv) an ensemble algorithm, such as a gradient boosting machine (GBM), a gradient boosting regression tree (GBRT), a random forest or a combination thereof, in particular an ensemble algorithm.
43. The method according to any one of clauses 23 to 42, wherein the detected at least one further property of the container other than the fill level, in particular the position of the container and/or the temperature, is used to determine the fill level of the liquid in the container.
44. The method according to any one of the preceding clauses, wherein the fill level of the liquid in the container is determined in step (vii) with the computer processor of the sensor device.
45. The method according to any one of clauses 1 to 44, wherein the fill level of the liquid in the container is determined in step (vii) with a computer processor being different from the computer processor of the sensor device.
46. The method according to clause 45, wherein the detected or processed audio signal and the digital representation of the container is provided to the computer processor via a wireless telecommunication wide area network protocol, in particular a low-power wide-area network protocol prior to the determination performed in step (vii).
47. The method according to any one of the preceding clauses, wherein the step of providing via the communication interface the determined fill level of the liquid in the container includes transforming the determined fill level into a numerical variable or a descriptive output, each being indicative of the fill level of the liquid in the container prior to providing the determined fill level of the liquid in the container via the communication interface.
48. The method according to any one of the preceding clauses, wherein providing the determined fill level of the liquid in the container via the communication interface includes displaying the determined fill level of the liquid of the container on the screen of a display device.
49. The method according to any one of the preceding clauses, wherein providing the determined fill level of the liquid in the container via the communication interface includes storing the provided fill level of the liquid in the container on a data storage medium, in particular in a database.
50. The method according to any one of the preceding clauses further including repeating steps (iii), (iv), (v), (vii) and optionally step (viii).
51. The method according to any one of the preceding clauses further including the step of determining an action to be taken for the container based on the provided fill level of the liquid in the container and the provided digital representation and optionally controlling taking the determined action.
52. The method according to clause 51, wherein the action is selected from scheduling transport cleaning, emptying, filling, movement, discarding or maintenance of the container, ordering of new container(s), changing the location of the container, powering down, powering up or adjusting behavior of the sensor device, activating an alarm, other actions, or any combination thereof.
53. The method according to any one of the preceding clauses further including determining with the computer processor an optimized maintenance interval based on the provided fill levels of the liquids in the container and the provided digital representation of the container.
54. The method according to any one of the preceding clauses further including the step of determining with the computer processor consolidated transports of empty containers based on the provided fill levels of the liquids in the containers and the provided digital representations of the containers.
55. A system for determining the fill level of a liquid in a container, comprising:
   a container;
   a sensor device for generating, detecting, and optionally processing at least one audio signal being indicative of the fill level of the liquid in the container;
   a data storage medium storing at least one data driven model parametrized on historical audio signals, historical fill levels of liquids in containers and historical digital representations of the containers;
   a communication interface for providing the digital representation of the container, the detected or processed audio signal(s) and at least one data driven model to the computer processor;
   a computer processor (CP) in communication with the communication interface and the data storage medium, the computer processor programmed to:
      a. receive via the communication interface the digital representation of the container, the detected or processed audio signal(s) and the at least one data driven model;
      b. optionally process the received detected audio signal(s);
      c. determine the fill level of the liquid in the container based on the received digital representation of the container, the received detected or processed audio signal and the received data driven model(s); and
      d. provide the determined fill level of the liquid in the container via the communication interface.
56. The system according to clause 55, wherein the computer processor (CP) is located on a server, in particular a cloud server.
57. The system according to clause 56, wherein the computer processor (CP) is corresponding to the processor of the sensor device.
58. The system according to any one of clauses 55 to 57, wherein the sensor device is permanently attached to the container or is detachable, in particular detachable.
59. The system according to any one of clauses 55 to 58, wherein the sensor device is physically coupled to the outside of the container by means of a bar.
60. The system according to clause 59, wherein the bar is detachably attached to the container.
61. The system according to clause 59 or 60, wherein the bar comprises an identification tag, preferably an RFID tag, in particular a passive NFC tag, being configured to provide the digital representation of the container or information being associated with the digital representation of the container via a communication interface to the computer processor (CP)
62. Use of the method of any one of clauses 1 to 54 for
   optimizing the maintenance interval of container(s) and/or
   reducing the total amount of circulating containers by consolidating transportation of empty and/or full containers and/or
   reducing the product cycle and/or
   ordering of new container(s) and/or
   taking old containers out of service.
63. A container comprising a fill level of a liquid, wherein the fill level of the liquid is determined according to the method of any one of clauses 1 to 54.
64. A client device for generating a request to initiate the determination of a fill level of a liquid in a container at a server device, wherein the client device is configured to provide a detected or processed audio signal being indicative of the fill level of the liquid in the container and a digital representation of the container to the server device.
65. A client device for generating a request to initiate the determination of a fill level of a liquid in a container at a server device, wherein the client device is configured to initiate acoustic stimulation of the container by means of a sensor device and wherein the sensor device is configured to provide a detected or processed audio signal being indicative of the fill level of the liquid in the container and a digital representation of the container to the server device.
66. A client device according to clause 64 or 65, wherein the server device comprises at least one data storage medium containing at least one data driven model, said model(s) being used for determining the fill level of the liquid in the container.

### BRIEF DESCRIPTION OF THE DRAWINGS

These and other features of the present invention are more fully set forth in the following description of exemplary embodiments of the invention. To easily identify the discussion of any particular element or act, the most significant digit or digits in a reference number refer to the figure number in which that element is first introduced. The description is presented with reference to the accompanying drawings in which:

FIG. 1 is a state diagram illustrating an example of a plurality of defined states of a container lifecycle according to embodiments of the method described herein

FIG. 2 is an exploded view of an illustrative sensor device according to embodiments of the method and system described herein

FIG. 3 is a flowchart illustrating an example of a method implementing different modes of the sensor device according to embodiments of the method and system described herein

FIG. 4a illustrates an example of a container comprising an attachment means for physical coupling of a sensor device to a container according to embodiments of the method and system described herein

FIG. 4b illustrates an example of a physical coupling of a sensor device to a container according to embodiments of the method and system described herein

FIG. 5 is a block diagram of a method for determining the fill level in a container according to the invention described herein

FIG. 6 is a block diagram of a preferred embodiment of the inventive method described herein

FIG. 7 is a process diagram of an illustrative embodiment of a machine learning algorithm determination method according to the present disclosure;

FIG. 8 is an example of a system according to the invention described herein

FIG. 9 is a block diagram illustrating an example of a system for remotely monitoring and managing containers according to embodiments of the system described herein

### DETAILED DESCRIPTION

The detailed description set forth below is intended as a description of various aspects of the subject-matter and is not intended to represent the only configurations in which the subject-matter may be practiced. The appended drawings are incorporated herein and constitute a part of the detailed description. The detailed description includes specific details for the purpose of providing a thorough understanding of the subject-matter. However, it will be apparent to those skilled in the art that the subject-matter may be practiced without these specific details.

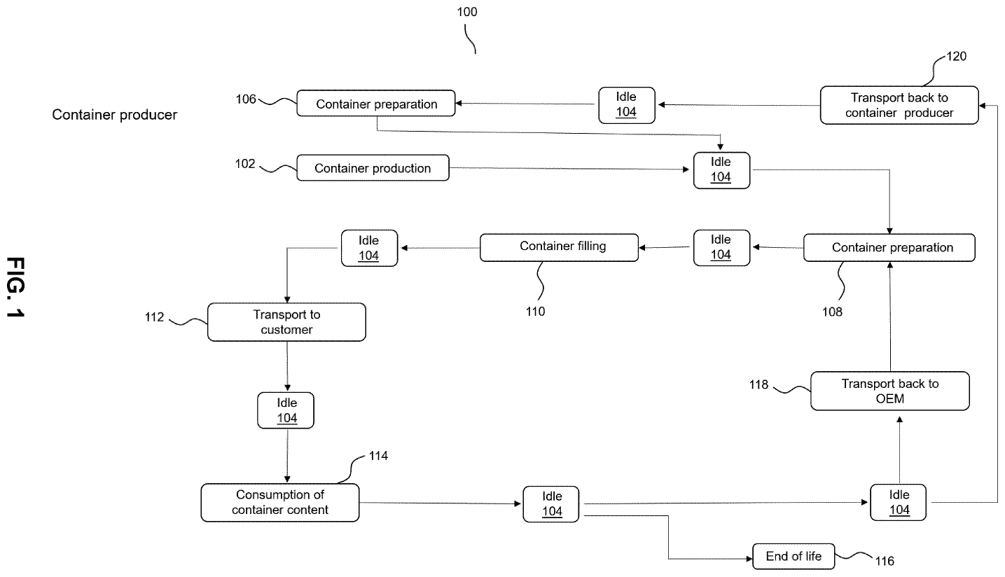

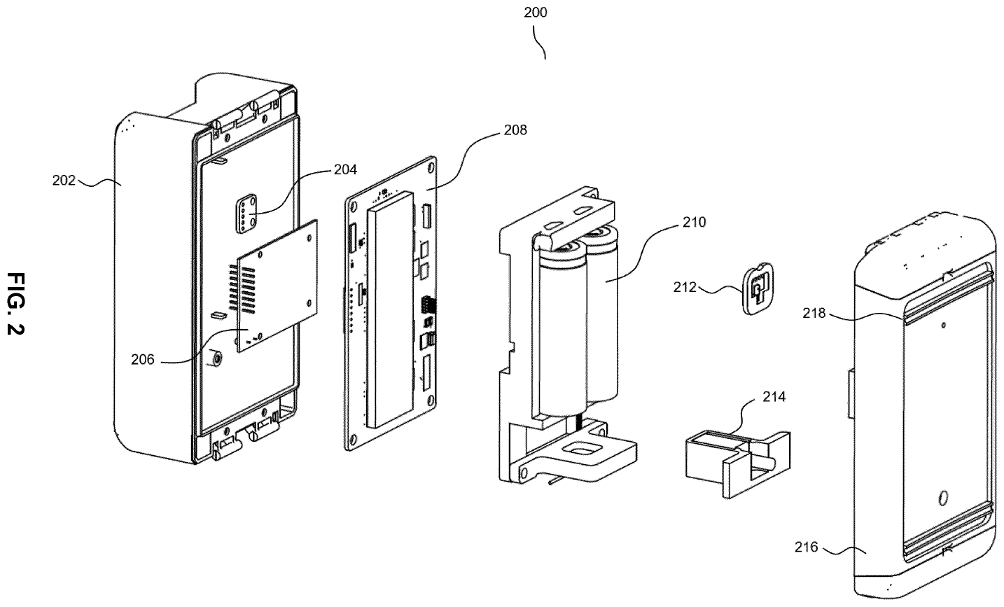

FIG. 1 is a state diagram illustrating an example of a container lifecycle involving a container producer, an OEM (i.e. a company selling goods contained in the containers) and a customer (i.e. a company consuming goods contained in the containers), according to embodiments of the method and system described herein. States 102, 106, 108, 110, 112, 114, 118 and 120 are referred to herein as an active state, while state 116 is referred to herein as passive state. Each arrowed line between states in FIG. 1 illustrates a state transition, with the direction of the arrow indicating the direction of the transition. A preferred lifecycle of a container or a plurality of containers only involves the OEM and the customer to reduce the amount of resources (e.g., compute, networking and/or storage resources) consumed in managing the lifecycle of a container or a group of containers.

In the idle state 104, the container is not handled, such as for example, produced, prepared, cleaned, filled, transported, emptied, or discarded. Thus, the idle state 104 does not require acquiring sensor data or only requires acquiring selected sensor data at predefined time slots. To minimize power consumption of the sensor device, said device may transition to a sleep mode in the idle state 104 of the container and may be activated (i.e. may be configured to transition to an active mode) upon passage of the container to an active state. “Sleep mode” may refer to a mode of operation of the sensor device during which the sensor device does not acquire sensor data, transmits any data or calculates any data. In contrast, “active mode” may refer to a mode of operation of the sensor device during with the sensor device acquires sensor data. Transition of the sensor device from an active mode to the sleep mode may occur in response to a variety of predefined conditions, such as: instructions or data received via a communication interface from a further device, network (for example a container management network) or database; determining a passage of a predetermined amount of time without any activity (e.g., no change in data acquired by the sensor device) or without a change to one or more predefined properties (for example location, movement/vibration, fill level); determining a predefined time of day (for example: after x hours of operation) and/or day of the week (for example weekend), month or year (for example holiday). Transition to the sleep mode may be performed by switching off all components of the sensor device which are not necessary for waking up the sensor device. Components being necessary for wake up may include the computer processor, selected further sensor(s) (for example movement sensor) and a timer component. If commercial communications networks (e.g., mobile telephone networks) are employed, the amount of commercial (e.g., cellular) charges may be reduced by reducing the use of communication services as a result of switching off the communication interfaces of the sensor device. The amount of power and/or money conserved/saved needs to be balanced against the desire or need to obtain the most current container status information. Transition of the sensor device from the sleep mode to the active mode may occur in response to a variety of predefined routines, such as setting a wake-up timer or a movement interrupt. The wake-up timer may be set by configuring a timer component to interrupt the computer processor of the sensor device after a predefined amount of time has elapsed. The timer component may have a predefined configuration or may be configured via a communication interface based on data from a network, such as a container management network, or a database. The movement interrupt may be set on a movement sensor to interrupt the computer processor in response to detecting a movement, for example during transport of the container within a company or to another company.

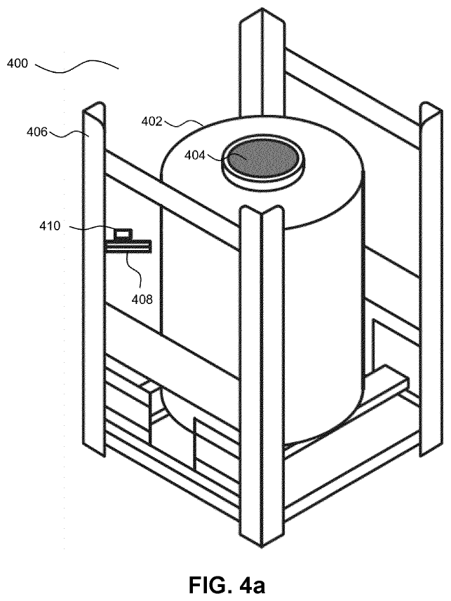

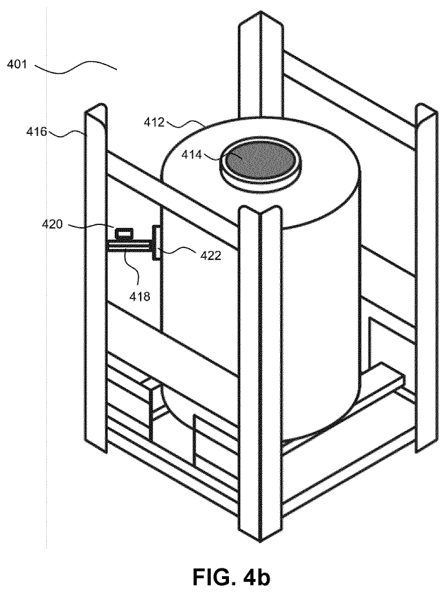

In the container production state 102, a container producer produces (e.g., manufactures) a container. In the container preparation state 106, a container producer prepares (e.g. repairs, cleans and/or tests), a used container, for example an empty container being transported from the customer to the container producer in state 122. After the container production state 102 or the container preparation state 106, the container may transition to the idle state 104 before the preparation state 108. In the preparation state 108, an OEM prepares a container, which may include repairing, cleaning and/or testing of the container. In one example, a physically coupling of the sensor device to the container may be performed, for example, as described in relation to FIGS. 4a and 4b during states 102 or 106. With preference, the coupling of the sensor device is performed either prior to the preparation state 106 or right after the preparation state 106 or in the container production state 102. Attachment of the sensor device in the container production state 102 allows to perform quality control measurements using the sensor device, for example by performing steps (iii) to (viii) of the method disclosed therein and using a data driven model trained on empty containers to detect deviations from the audio signal(s) of the manufactured container from audio signal(s) of historical containers having the required quality. This allows to easily determine whether the container has been damaged during the manufacturing process without human interactions or expensive X-ray inspections.

Attachment of the sensor device prior to the preparation state 106 may be preferred if the sensor device is not damaged by the actions performed in the preparation state 106 and may be used to monitor and optionally control the preparation process, for example by monitoring the temperature and duration of the cleaning. Based on the recorded data, the quality of the cleaning may be derived, or the sensor device may be configured to provide a notice and/or alarm if a certain threshold is reached, such as a certain predefined temperature threshold, or stop the cleaning process. In case the preparation state 108 performed by the OEM requires the use of harsh cleaning agents, the sensor device may be detached prior to performing the preparation state 108 and reattached after the preparation state 108 has been completed. In another example, a physically coupling of the sensor device to the container may be performed during state 108. This may be preferred if the container has not been equipped with the sensor device during the container production state 102 or the container preparation state 106. After the preparation state 108, the container may transition to the idle state 104 before entering the container filling state 110.

In the container filling state 110, the OEM fills the container with liquid contents, for example a liquid coating composition as described previously. The sensor device may determine the transition based on a change in location or by receiving instructions. The change in location may be determined by the sensor device as described elsewhere and may be provided via a communication interface to a network, such as a container management network, or database for further use. The instructions may be received from a user via a network, such as a container management network, connected with the sensor device. In one example, the sensor device may be configured to store, for example, during the container filling state 110, a product identifier of the container, an identifier of the sensor device itself, information about the contents with which the container is being filled, product specifications of any of the foregoing, an address or other location ID of an intended customer, other information, or any suitable combination of the foregoing. Such information may be stored in a non-volatile memory of the sensor device, and portions of such information may be obtained via the communication interfaces. In another example, the previously mentioned information may be associated with the container ID, stored in a database, and retrieved by the sensor device upon detection of the container ID as previously disclosed. This allows to reduce the capacity of the internal data storage of the sensor device and thus the costs of the sensor device. Moreover, the information can be more easily updated since it does not require to provide the updated information to the sensor device.

After the container filling state 110, the container may transition to the idle state 104 before being transported to the customer. In the transport to customer state 112, the container is transported from the OEM to customer premises (including premises on behalf of the customer). The sensor device may be configured to transition from a sleep mode in the idle state 104 to an active mode during the transport to customer state 112 in response to determining a change in location with respect to the container filling state 110. The change in location with respect to the container filling state 110 may be determined using the networking technologies described elsewhere herein, for example, by detecting a change in GPS location or a transition between one or more Wi-Fi networks. For example, the sensor device may have recorded the Wi-Fi network ID and/or GPS location of the filling location and the computer processor of the sensor device may determine when a determined value of one of these parameters for a current location no longer matches the recorded values. The sensor device may be configured to cycle between the sleep mode and the active mode during transport to a customer. To save energy, the sensor device may remain in the active mode during the transport to customer state 112 for only a very small percentage of time relative to time spent in the sleep mode. During the transport to customer state 112, information detected from further sensors of the sensor device may be analyzed to determine whether there has been any damage or other degradation of the container or the quality of the liquid inside the container. For example, the sensor device may be woken up from sleep in response to movement detected by the movement sensor. The extent of the detected movement may allow to derive whether a damage of the container or the contents has occurred during transport. Other sensor data which may be gathered and analyzed includes air temperature, humidity, and pressure. These data may be used to estimate “best-if-used-by” or “best before” dates, expiration dates and the like. This same analysis may be performed while the container is in other states as well, for example, the container filling state 108 and the consumption of container content state 114.

After the transport to customer state 112, the container may transition to the idle state 104 before being used at the customer, i.e. before the liquid is withdrawn from the container by the customer. In the consumption of container content state 114, the contents of the container are consumed by the customer, for example, in one or more iterations. During this time, the filling level of the liquid in the container is monitored using the methods and systems described therein. Activation of the fill level determination may occur in response to determining that the container has arrived at a site of a customer, which may be determined using one or more of the networking technologies described previously using predefined parameters for the customer sites. In the consumption of container content state 114, the contents of the container maybe consumed (i.e., emptied) all at once or in many iterations over time. An all-at-once emptying and each iteration of an emptying may be referred to herein as “emptying event.” An emptying event often involves movement of a container to a defined location, a coupling/uncoupling (e.g., screwing/unscrewing) of connectors to tubes, pipes, pumps, etc., and a vibration during emptying (for example by the use of stirring devices prior to emptying/during emptying to ensure a homogenous composition of the liquid). The sensor device may be configured to initiate the determination of the fill level before or after an emptying event, such that the degree of background noises is reduced, thus increasing the accuracy of the fill level determination. The sensor device may obtain information concerning an emptying event via a communication interface from a network, such as a container management network, which may forward data on a planned emptying event or data on an occurred emptying event to the sensor device or by detecting a change in location as described previously. The consumption of container content state 114 may transition to the idle state 104 before the container is transported back to the OEM in the transport back to OEM state 118, discarded by the customer (i.e. resulting in the end of life (EOL) state 116) or transported back to the container producer in the transport back to container producer state 120.

In the transport back to OEM state 118, the container is transported back to the OEM and transitions to the idle state 104 prior to the container preparation state 108. In the transport back to container producer state 120, the container is transported back to the container producer and may transition to the idle state 104 prior to the container preparation state 106. The sensor device may be configured to transition from a sleep mode in the idle state 104 to a cycle between sleep mode and active mode during the transport back to OEM state 118 or transport back to container producer state 120 in response to determining a change in location with respect to customer site as described previously.

The data acquired by the sensor device during the active states can be used within a container management network to significantly reduce the idle states 104 of the container within the container lifecycle because the acquired data can be used to schedule the next state of the lifecycle or to predict the time point when the next stage will approximately be reached, thus optimizing the lifecycle of the container and therefore reducing the costs associated with the idle states 104 of the containers.

FIG. 2 is an exploded view of an illustrative sensor device 200 comprising a housing 202 and a cover 216 covering the housing 202 of the sensor device 200. The housing 202 comprises a microphone 204, such as a MEMS microphone previously described, and an NFC reader board 206. The NFC reader board 206 of the sensor device 200 is used to retrieve information, such as the container ID, stored on the identification tag, such as an NFC tag, present on the bar attached to the frame of the container as described in relation to FIGS. 4a and 4b.

The sensor device 200 further comprises a main board 208, such as a printed circuit board (PCB). The main board 208 comprises a computer processor, such as a microprocessor, communication modules, sensors, such as an inertial measurement unit (IMU) to determine the specific force, angular rate, and orientation of the sensor device, using a combination of accelerometers, gyroscopes, and optionally magnetometers and a climate sensor, and a memory, such as random access memory and/or a nonvolatile memory (e.g. FLASH) and optionally a timer component and/or a trusted platform module (TPM).

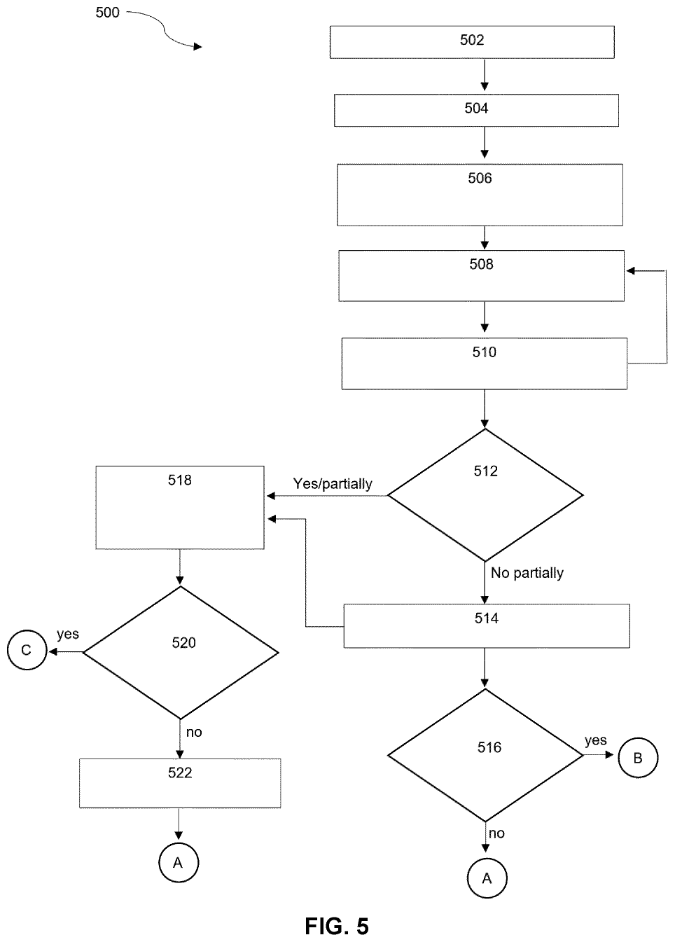

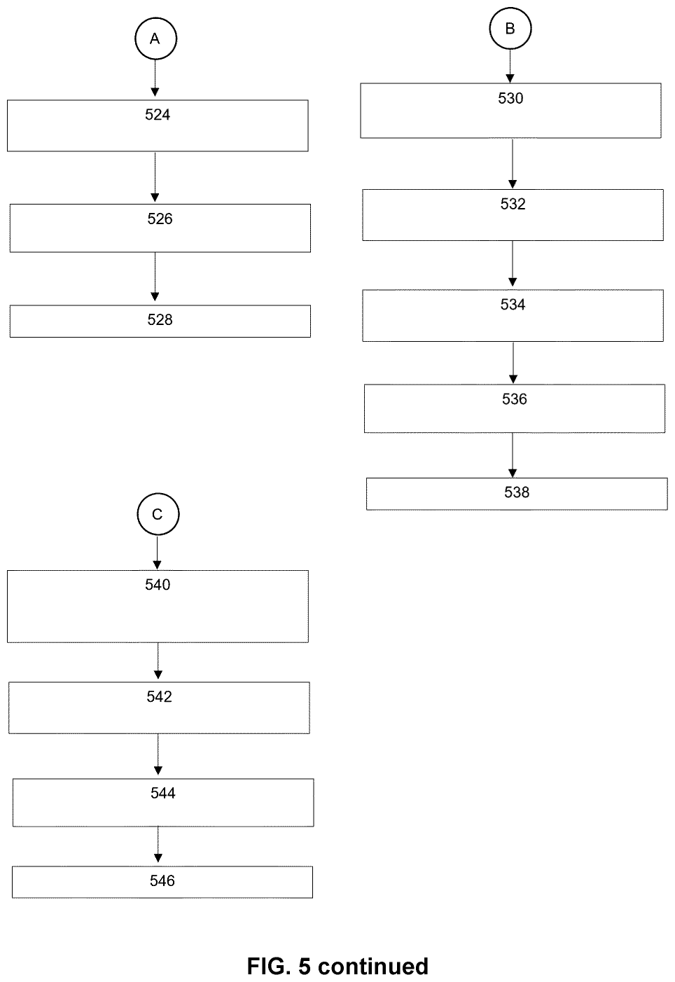

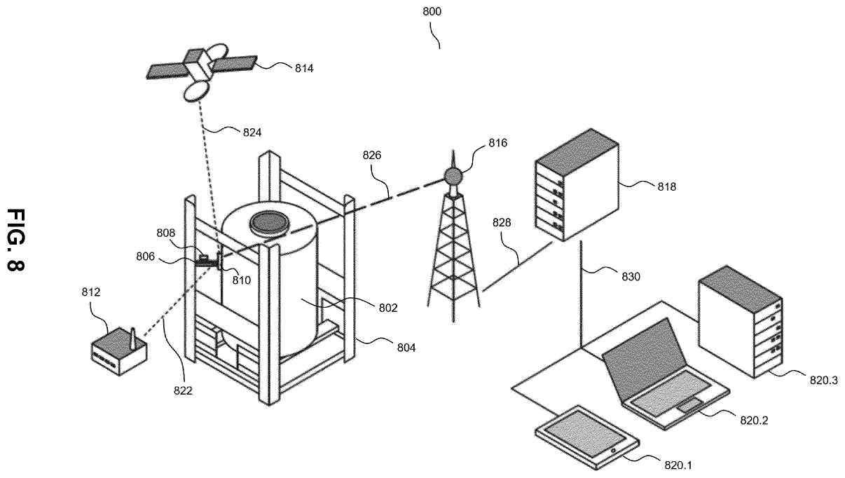

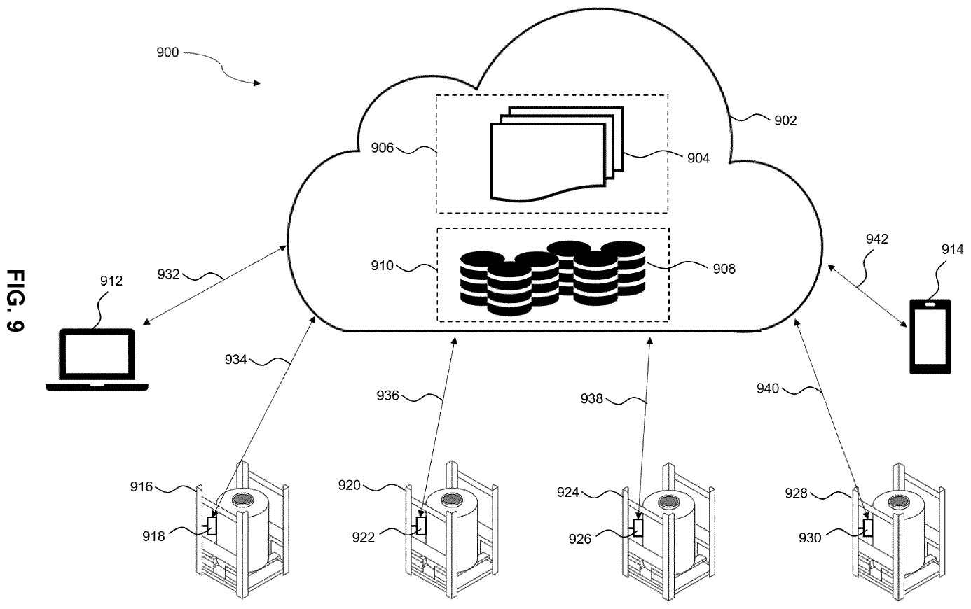

The processor may be an ARM CPU or other type of CPU and may be configured with one or more of the following: required processing capabilities and interfaces for the other components present in the sensor device described herein and an ability to be interrupted by a timer component and by the IMU. For this purpose, the components of the sensor device 200 are connected via digital and/or analog interfaces with the processor present on the main board 208. In one example, the microprocessor of the sensor device 200 is used to process the audio signal(s) detected by microphone 204 and/or 212 after acoustic stimulation of the container with actuator 214. In another example, the processing is done on a further processor not being present inside the sensor device 200 (not shown) and the detected audio signal(s) are provided to the further processor via a communication interface using any one of the communication modules present on the main board 208 of the sensor device 200. The further processor may be present inside a processing device, such as a server, or may be present within a cloud computing environment, such as a container management network as described in relation to FIGS. 8 and 9. “Cloud computing environment” may refer to the on-demand availability of computer system resources, especially data storage (cloud storage) and computing power, without direct active management by the user and may include at least one of the following service modules: infrastructure as a service (IaaS), platform as a service (PaaS), software as a service (SaaS), mobile “backend” as a service (MBaaS) and function as a service (FaaS). The fill level of the liquid in the container may either be determined with the microprocessor of the sensor device 200 or with a further computing device as described in relation to FIG. 5. If the fill level is determined with a further computing device, the sensor device 200 provides the detected or processed audio signal(s) to the further processor via the communication interface prior to determination of the fill level as described elsewhere herein. The data storage medium on the main board 208 of the sensor device may be used to store detected, analyzed, or processed data and to prevent data loss in case the communication between the sensor device and further devices of the system is interrupted during data transfer.

The communication interfaces include at least one cellular communication interface enabling communications with cellular networks, and may be configured with technologies such as, for example, Long-term Evolution (LTE) and derivatives thereof like LTE narrowband (5G) and LTE FDD/TDD (4G), HSPA (UMTS, 3G), EDGE/GSM (2G), CDMA or LPWAN technologies. Cellular communications are to enable a sensor device to communicate with one or more other devices of a container management network, such as the system described in relation to FIGS. 8 and 9. In one example, the communication with cellular networks is used to detect the of geographic location of a container having coupled thereto the sensor device 200, including detecting a change in location from one cell of a cellular network to another cell, and a relative location of a container within a cell, for example, a radial distance from the cell phone base station. In another example, the communication with cellular networks is used to transmit data acquired and/or processed by the sensor device to a further computing device, such as a server (see for example FIG. 8). In yet another example, the communication with cellular networks is used to detect a change in the location and to transmit data as previously described. The at least one cellular communication interface may be, include, or be part of a cellular modem. The communication interfaces are furthermore configured to implement Wi-Fi technology, e.g., in accordance with one or more 802.11 standards, to allow determination of the location of the container or change in the location of a container having the sensor device attached thereto indoors. The Wi-Fi technology may be used to connect with hotspots at various locations and during various states of a container lifecycle described in relation to FIG. 1, and may serve as an option for establishing a communication path within a further devices or a container management network (see FIG. 9), for example, as an alternative, or in addition to a cellular communication path. The sensor device 200 may include one or more antennas corresponding to the one or more of the previously described communication technologies. Each antenna may be integrated, if suitable, within the main board 208 or may be physically connected to the main board 208 and/or the housing 202 and/or cover 216 of the sensor device 200. The communication interfaces are furthermore configured to implement GNSS technology to allow determination of the container having attached thereto sensor device 200 outdoors.

The inertial measurement unit (IMU) is used to determine the movement of the container having attached thereto the sensor device 200 by determining the specific force, angular rate, and orientation of the sensor device 200 using a combination of accelerometers, gyroscopes, and optionally magnetometers. The climate sensor is configured to measure the climate conditions of the sensor device 200, e.g., inside a housing of the sensor device 200. Such climate conditions may include any of: temperature, air humidity, air pressure, other climate conditions or any suitable combination thereof, in particular the temperature. While the climate sensor is illustrated as being part of the main board 208, one or more additional climate sensors may be external to the main board 208, within the sensor device 200 or external thereto. Climate sensors located external to the main board 208 may be linked through digital and/or analog interfaces, such as one or more M12.8 connectors, and may measure any of a variety of climate conditions, including but not limited to: temperature, humidity and pressure or other climate conditions of a container, the contents thereof (e.g., liquid, air) and/or ambient air external to the container.

The timer component may provide a clock at any of a variety of frequencies, for example, at 32 KHz or lower, for the processor of the main board 208. The frequency of the clock may be selected to balance a variety of factors, including, for example, fiscal cost, resource consumption (including power consumption) and highest desired frequency of operation.

The Trusted Platform Module (TPM) may be used to encrypt data and to protect the integrity computer processor. The TPM may be used for any of a variety of functions such as, for example, creation of data for, and storage of credentials and secrets to secure, communication with one or more networks (e.g., any of the networks described herein); creation of TPM objects, which are special encrypted data stored in the nonvolatile memory outside the TPM, that can only be decrypted through the TPM; creation of data to be communicated and stored as part of transaction records (e.g., blockchain records) or registers, signing of files to secure the integrity and authenticity of services, e.g., services described herein; enablement of functions like Over-the-Air (OtA) update of firmware, software and parameters of the sensor device 200; other functions; and any suitable combination of the foregoing.

The sensor device 200 further comprises an energy source 210, for example two batteries commonly used in industry. The batteries may be charged via an M12.8 connector or may be exchanged if empty. The processor may be connected with the batteries via digital and/or analog interfaces such that the battery level can be monitored by the processor. The processor may be configured to provide a notice/alarm in case the battery level reaches a predefined value to avoid malfunction of the sensor device 200 due to lack of power. The processor may also predict the battery lifetime based on historic and/or actual power consumption and may provide the prediction to a further device via the communication interface.

The sensor device 200 comprises a further microphone 212, such as a MEMS microphone described previously, and an actuator 214, such as a vibration motor described previously. Upon physical coupling of the sensor device to the outside of the container (see for example FIG. 4b), the actuator of the sensor device is able to acoustically stimulate the container and the resulting audio signals are detected with microphone 212 and/or 204. For this purpose, the cover 216 comprises openings for the actuator and the microphone. The actuator is controlled by the microprocessor on the main board 208 of the sensor device 200 according to its programming. To prevent entering of dust into the openings in the cover, cover 216 comprises sealing lips 218. In this example, the cover comprises 2 sets of sealing lips 218 on the upper and lower end of cover 216. In another example, the sealing lips may be circumferentially aligned around cover.

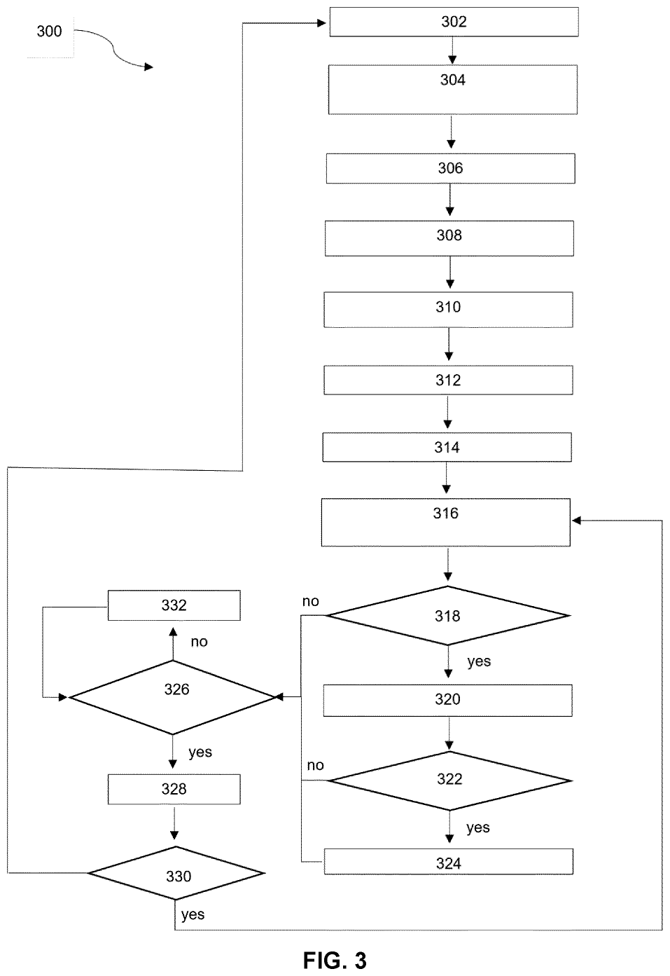

FIG. 3 is a flowchart illustrating an example of a method 300 implementing different modes of a sensor device, such as sensor device 200 as described in relation to FIG. 2. In step 302, a sleep mode is initiated. The sleep mode may be initiated in the idle state of the container as described in FIG. 1 to reduce power consumption of the sensor device such that the lifetime of the batteries of the sensor device is extended. This allows to increase the maintenance intervals and therefore the overall cost associated with operation of the sensor device. Transition of the sensor device from an active mode to the sleep mode may occur in response to a variety of predefined conditions, as described previously.

After initiating the sleep mode, all components of the sensor device which are not necessary for waking up the sensor device are switched off in step 304. For example, with reference to the sensor device 200 of FIG. 2, all components except for the IMU, the timer component and the processor maybe powered down, including all the communication interfaces being present on the main board 208, the sensors, the microphones 204, 212 and the actuator 214. By powering off components of the sensor device not needed for wake-up, power may be conserved, thus prolonging the lifetime of the batteries of the sensor device and therefore the overall costs associated with the operation of the sensor device.

In order to allow wake up of the sensor device, interrupt event(s) are set in step 306. Interrupt events may include a wake-up signal from the timer component at a predefined time and/or interval and/or detection of a movement by the movement sensor. In one example, a wake-up timer may be set. The wake-up timer may be set by configuring a timer component to interrupt the computer processor of the sensor device after a predefined amount of time has elapsed. The timer component may have a predefined configuration or may be configured via a communication interface based on data received from a network, such as a container management network, or a database. In one example, the wake-up timer for the sensor device may be configured to coincide with a schedule of a time slot during which the sensor device is scheduled to transmit data via a communication interface to a further device as described in relation to FIGS. 8 and 9. The movement interrupt may be set on the movement sensor to interrupt the computer processor in response to detecting a movement, for example during transport of the container within a company or to another company

In a step 308, the defined state of the sensor device may be changed to the sleep mode.

In a step 310, at least one interrupt event, such as a wake-up signal from the timer component or movement is detected.

In a step 312, the defined state of the sensor device is changed to the active mode in response to detecting an interrupt event in step 310.

In a step 314, one or more of the components of the sensor device may be powered on, including any of those described in relation to FIG. 2, for example, the climate sensor and interfaces to same and communication interfaces in response to detecting the interrupt event(s). Which components to turn on may depend, at least in part, on the functionality and parameter values with which the sensor device has been configured. Transition of the sensor device from the sleep mode to the active mode may occur in response to a variety of predefined routines, such as setting a wake-up timer or a movement interrupt. The steps 312 and 314 collectively may be considered as activating the sensor device and may be performed concurrently at least in part or in a reverse order than the order displayed in FIG. 3.

In step 316, the sensor device performs at least one action which is programmed when the sensor device is in the active mode. Such actions may include determining the temperature, determining the location of the sensor device, acoustically stimulating the container by means of the actuator, detecting audio signal(s) generated from the acoustic stimulation or from background noises and any combination thereof. The action may vary depending on the programming of the sensor device, optionally considering the state of the container (see FIG. 1). In one example, the determination of location may be triggered by detecting a movement of the container having affixed thereto the sensor device with the IMU. In another example, acoustically stimulating the container by means of the actuator, detecting audio signal(s) generated from the acoustic stimulation or from background noises may be triggered because a predefined or determined time point has been reached. The detected sensor data may be stored in the memory of the sensor device along with a current time. It should be appreciated that the current time may be determined any time data, such as sensor data, location data, audio signal(s) is detected, information determined, and such current time may be recorded and/or transmitted along with information pertaining to the detected or determined data.

In a step 318, it may be determined if the detected audio signal(s) are to be processed by the processor of the sensor device or remotely, i.e. by a further device. Determination may be made by the processor of the sensor device according to its programming as described in relation to FIG. 5.

If it is determined in the step 318 that the detected audio signal(s) are to be processed by the processor of the sensor device, the in step 320, the processor of the sensor device may perform the processing as described in relation to FIG. 5. The processed audio signal(s) may be stored in the memory of the sensor device prior to further processing as described below. In a step 322, it may be determined if the fill level is to be determined by the processor of the sensor device or remotely, i.e. by a further device. Determination may be made by the processor of the sensor device according to its programming as described in relation to FIG. 5. If it is determined in the step 322 that the fill level is be determined by the processor of the sensor device, the in step 324, the processor of the sensor device may perform the determination as described in relation to FIG. 5. After the fill level has been determined, the method 300 proceeds to step 326. If it is determined in the step 322 that the fill level is not to be determined by the processor of the sensor device, the method 300 proceeds to step 326.

If it is determined in the step 318 that the detected audio signal(s) are not to be processed by the processor of the sensor device, then the method proceeds to step 326, where it is determined whether there is connectivity to a further device or a server environment, such as a gateway or server of the system described in FIGS. 8 and 9. The determination may be made using a communication interface of the main board 208, for example, a Wi-Fi and/or cell phone interface thereof. If it is determined in the step 326 that there is network connectivity, then in a step 328 data (e.g., any of the information described above in relation to the step 318 or 320) may be transmitted to further device or server environment. If it is determined in the step 318 that there is no network connectivity, then the method 300 proceeds to step 332 in which the sensor device stores the data in the memory present on the main board 208 and returns to step 326 after a predefined time point.

After data has been transmitted in step 328, the method proceeds to step 330. In step 330, it may be determined whether to have the sensor device remain awake, for example, based on the data received back from the further device or server environment or according to its programming. If it is determined to not remain awake, then the method 300 proceeds to the step 302 in which the sensor device may initiate the sleep mode. If it is determined to remain awake, then the method 300 may proceed to step 316 and perform the actions previously described.

FIG. 4a illustrates an example of a container comprising an attachment means for physical coupling of a sensor device to a container. In this example, the container 400 is a metal intermediate bulk container (IBC) comprising a metal container 402 having an opening 404 for filling and emptying processes. In another example, the container may be a plastic IBC, a composite IBC or any other container previously described. The metal container 402 is fixed inside a metal framework 406 to allow for easy transportation and stacking of the metal IBC. The container comprises an attachment means 408 for physically coupling the sensor device (not shown, see for example FIG. 4b) to the outside of the container. In this example, the attachment means 408 is a metal bar which can be detachably clamped to the metal framework 406 of the container. Use of a detachable attachment means 408 avoids recertification of the container which must be performed in case the container is permanently modified. The attachment means comprises an identification tag 410 for storing container related information. In this example, the identification tag 410 is a passive NFC tag comprising the container ID. The identification tag 410 may be attached to the attachment means 408 permanently or may be detachable, such that it can be removed prior to cleaning to prevent destruction of the identification tag 410 during the cleaning process.

FIG. 4b illustrates an example of a physical coupling of a sensor device to a container. In this example, the container 402 is a metal intermediate bulk container (IBC) comprising a metal container 412 having an opening 414 for filling and emptying processes. In another example, the container may be a plastic IBC, a composite IBC or any other container previously described. The metal container 412 is fixed inside a metal framework 416 to allow for easy transportation and stacking of the metal IBC. The container comprises an attachment means 418, such as a bar, for physically coupling the sensor device 422 (such as sensor device 200 described in connection with FIG. 2) to the outside of the container. In this example, the attachment means 418 is detachably clamped to the metal framework 416 to avoid recertification as described previously. The sensor device 420 is attached to the attachment means by means of a screw which can also be used to guarantee that the sensor device 420 is in contact with the outside of the container 401. The sensor device 420 can be removed from the attachment means 418 by unscrewing the screw, thus allowing easy attachment and removal of the sensor device 420, for example during cleaning processes to avoid destruction of the sensor device 420. The attachment means 418 also comprises an identification tag 420 as described in connection with FIG. 4a. The sensor device 420 can be used to retrieve the information stored on said tag as described in connection with FIG. 2.

FIG. 5 is a flowchart illustrating an example of a method 500 for determining the fill level of a liquid in a container, according to embodiments described herein. The method 500 is implemented on a container being filled with a liquid and having a sensor device (e.g., the sensor device 200 as described in FIG. 2) physically coupled thereto. In this example, the container is a metal IBC container as described in relation to FIGS. 4a and 4b which is filled with a liquid coating composition, such as a liquid basecoat composition, for use in the automotive industry. The method 500 may include consideration of a current state of a container (see for example FIG. 1) and one or more properties detected with the sensor device (e.g., any of those described in herein).

In a step 502, the sensor device is attached to the container by physically coupling the device to the container, as for example, described in relation to FIG. 4b by means of a bar which is clamped into the metal framework of the container. The bar comprises an identification tag, such as a passive NFC tag, having stored thereon the container ID and the sensor device can be physically coupled to the container by means of a screw after attaching the sensor device to the bar.

After attaching the sensor device to the container, the sensor is initialized in step 504, which may include loading software (including firmware) and software parameters, activating certain functions of the sensor device or defining an initial state for the container, for example a state as described in relation to FIG. 1. The initial state of the container, for example idle state 104, may be configured for the sensor device as part of loading the software. The software and software parameters may define one or more aspects of the functionality of the sensor device and/or components thereof described herein. For example, one or more algorithms may be specified by such software. An algorithm may be generic to all defined states of the lifecycle of the container, specific to one or more defined states, or even specific to certain modes or events within a certain predefined state. The functionality (i.e., behavior) of the sensor device, for example, one or more algorithms stored thereon, may be defined to be specific to particular use(s), industry(s) or content(s) that will be contained within the container (e.g., type of liquid product, such as coating composition, cosmetic etc.) and the expected lifecycle of the container given the intended use (e.g., commercial process) involving the contents.

In step 506, the digital representation of the container is provided to the processor of the sensor device. In this example, the container ID is used to provide the digital representation. For this purpose, the container ID stored on the identification tag of the bar is retrieved by the sensor device via the NFC reader board present in the sensor device. The container ID is then used to retrieve the digital representation of the container from a database having stored therein the container ID associated with the digital representation of the container. To this end, the sensor device retrieves the digital representation of the container via a communication interface from the database using the previously acquired container ID. In this example, the digital representation of the container comprises data on the size of the container, in particular data on the filling volume of the container, data on the content of the container, data on the initial filing level, filing date, data on the location of the container, data on the age of the container, data on the use cycle of the container, data on the maintenance intervals of the container, data on the maximum life time of the container, expiry date of container content, planned emptying events, and any combination thereof. The digital representation of the container stored in the database may be updated frequently, for example after change of a state of the container as described in relation to FIG. 1, and updating of the digital representation may initiate retrieval of the updated digital representation of the container by the sensor device via the container ID stored on the identification tag as previously described. For example, the processor of the sensor device may receive via the communication interface an instruction to read the container ID and to obtain the digital representation from the database using the container ID. The digital representation of the container may be used control the acoustical stimulation of the container by means of the sensor device, for example by implementing an algorithm in the computer processor of the sensor device which determines time point(s) when the background noises are reduced to a minimum based on the provided digital representation and then starts the acoustic stimulation at the determined time point(s). This allows to improve the accuracy of the fill level determination since the detected audio signal is not overlayed with background noises, thus rendering the processing step more difficult. In another example, the digital representation of the container is stored on the identification tag and is retrieved directly from the tag using the sensor device as described previously.

In step 508, the container is acoustically stimulated by means of the sensor device. A suitable sensor device is described in relation to FIG. 2. For this purpose, the actuator of the sensor device, in particular a vibration generator, beats on the outside of the container with a beating energy of 0.3 to 0.5 newton meter. This beating energy is sufficient to generate audio signal(s) being indicative of the filling level. In case the sensor device is used in explosion protected areas, the actuator comprises a material with does not generate sparks when beating on the metal outer wall of the container. The beating is controlled by the processor of the sensor device according to its programming. In one example, the beating is performed at predefined time point(s) which may be provided to the processor via the digital representation of the container or via a further database or may be determined by the processor based on provided data, such as the digital representation of the container or data acquired by further sensors of the sensor device. The predefined time point(s) may be selected such that the background noises are reduced to improve the accuracy of the fill level determination because the detected audio signal(s) are not heavily overlaid with background noises which complicate the identification of audio signal(s) being indicative of the fill level from the detected audio signal(s). In another example, the beating may be performed at random time point(s). In yet another example, the beating may be triggered via an external device, such as a further computing device, by a user input. This may be preferred if current information on the fill level is needed and the last fill level determination has been made some time ago. Since each acoustic stimulation and following fill level determination results in energy consumption, the acoustic stimulation and fill level determination has to be balanced against the battery lifetime of the batteries of the sensor device. It may therefore be preferred to perform the fill level determination at predefined time point(s) which may take into consideration emptying events of the container. This step may also include determining at least one further property not corresponding to the fill level, for example the temperature, the location, or the battery level. The acquired data may be stored along with the current time in the memory of the sensor device and may be analyzed by the processor of the sensor device to determine a time point for acoustic stimulation as described below. This determination may be performed prior to acoustic stimulation or after acoustic stimulation. In case the determination is performed prior to acoustic stimulation, the acoustic stimulation may be triggered based on the acquired and optionally analyzed sensor data of further sensors of the sensor device as described above.

In step 510, the audio signal(s) resulting from the acoustic stimulation are recorded by at least one microphone, in particular at least one soundproofed and directed MEMS microphone, and provided to the processor of the sensor device via a communication interface. The detected audio signal(s) may include background noises, for example, if the acoustic stimulation is performed during a time period with background noises. To identify the background noises, the sensor device may include a second microphone used to detect such noises so that the detected background noises can be subtracted from the detected audio signal(s) resulting from the acoustic stimulation. This allows to improve the accuracy of the fill level determination and allows to perform step 508 during time point(s) having background noises, thus rendering it possible to determine the fill level accurately at any desired time point irrespective of the background noises existing at the measuring time. The generated audio signal(s) may be detected with the first microphone from a predefined time point after the stimulation, because the audio signal(s) being indicative of the fill level may be generated with a time-shift with respect to the stimulation. In this example, the generated audio signal(s) may be detected 0.3 to 0.5 seconds after acoustical stimulation of the container by means of the actuator of the sensor device. To identify background noises present during acoustical stimulation, the second microphone may detect noises during a predefined time point prior to and after acoustic stimulation. Since dampening of the generated audio signal(s) is rather strong, the generated audio signal(s) may be detected up to a predefined time point to reduce the amount of data which needs to be processed. In this example, the generated audio signal(s) are detected with the first microphone for a period of 1.6 seconds after acoustical stimulation.

Steps 508 and 510 may be repeated several times to increase the accuracy of the fill level determination. The number of repetitions must be balanced with respect to improvement of accuracy and decrease of battery lifetime. In one example, steps 508 and 510 are repeated 5 times. Repetition of more than 5 times does no longer increase the accuracy significantly. Therefore, repetition of steps 508 and 510 for more than 5 times would have a negative influence on the battery lifetime of the sensor device without gaining any further benefit in terms of accuracy improvement and is therefore less preferred.

In step 512, it is determined whether the detected audio signal(s) are to be processed by the processor of the sensor device. This determination is made by the processor of the sensor device according to its programming. In one example, processing of the detected audio signal(s) with the sensor device includes full processing of the detected audio signal(s). In another example, processing of the detected audio signal(s) with the sensor device includes partial processing of the detected audio signal(s) and forwarding the partially processed audio signal(s) to the further device for further processing (see step 518). “Full processing” includes at least the following steps: digital sampling, aligning of audio samples, calculation of Fourier spectrum of the aligned audio samples. Full processing may further include extraction of predefined features form the calculated Fourier spectrum and combination of extracted features. “Partial processing” includes at least one step less than the full processing. It may be beneficial to perform processing of the audio signal(s) using an external device to reduce the power consumption of the sensor device.

If in step 512, it is determined that the detected audio signal(s) are fully or at least partially processed by the processor of the sensor device, the method proceeds to step 514, and the processor of the sensor device processes the audio signal(s) according to its programming. For example, the sensor device may determine to perform processing of the detected audio signal(s) in case the battery level is above a predefined threshold to avoid loss of power during processing due to low battery levels. Processing of the audio signals may include digital sampling of the detected audio signal(s) with the computer processor. Digital sampling may be performed using pulse-code-modulation (PCM) or pulse-density-modulation (PDM) as described previously. The audio samples may be further processed by removing the background noises detected by the second microphone from the audio samples generated by the acoustic stimulation and detected by the first microphone of the sensor device. In one example, the audio samples are further processed by aligning the audio samples, calculating the Fourier spectrum of the aligned audio samples, extracting predefined features being indicative of the fill level and reducing the dimension of the extracted features or aggregating the extracted features as described above. In this example, the Fourier spectrum of the aligned audio samples is calculated using STFT by splitting the aligned audio sample(s) into a set of overlapping windows according to a predefined size, creating frames out of the windows and performing DFT on each frame. The predefined size may range from 4 to 4096, such as 4, 8, 16. 128 or 4096. Afterwards, the magnitude of the complex numbers in the matrix of complex numbers obtained from STFT is calculated to obtain the magnitudes of the frequency and the phases of the frequency (also denoted as “raw features” in the following). In this example, the following predefined features are extracted from the raw features: the (normalized) average frequency, the (normalized) median frequency, the standard deviation of the frequency distribution and the skew of the frequency distribution. Said extracted features are afterwards aggregated as described above. In another example, the following predefined features were used: frequency with the highest energy, the (normalized) average frequency, the (normalized) median frequency, the deviation of the frequency distribution from the average or median frequency in different L^{p} spaces, the spectral flatness, the (normalized) root-mean-square, fill-level specific audio coefficients, the fundamental frequency computed by the yin algorithm, the (normalized) spectral flux between two consecutive frames]. Extraction and combination of predefined features result in an improved accuracy of the determination of the fill level using the data driven model and the digital representation of the container, especially in borderline cases between the container being empty and the container still comprising some liquid. The result of the processing as previously described may be stored on the memory of the sensor device prior to determining the fill level as described previously. Step 514 may be performed on the sensor device if the computing power is sufficiently high to perform the processing within a reasonable time frame and the power consumption during determination is acceptable, i.e. it does not decrease the lifetime of the batteries of the sensor device unacceptable.

If in step 512, it is determined that the detected audio signal(s) are to be fully or partially processed by the processor of a further device, the method proceeds to step 518. The further device may be computing device, for example a server, stationary or mobile computing device, such as described in relation to FIGS. 8 and 9. The processor of the sensor device transmits the detected or partially processed audio signal(s) and data acquired by further sensors, such as the temperature, location, battery level, via a communication interface, such as a mobile communication interface, to the further device. To avoid data loss, the detected audio signal(s) or partially processed audio signal(s) may be stored in the memory of the sensor device prior to data transmittal. In one example, the data is transmitted to the further device via an LPWAN communication. LPWAN allows reliable data transmission over long ranges and under difficult conditions and requires low power consumption for data transfer. This allows to use a further device which is not in close proximity to the sensor device, thus rendering it possible to centralize data processing and to use a single further device for the processing of data received from multiple sensor devices from various locations. Moreover, the use of LPWAN allows data transmittal with low power consumption, thus reducing the maintenance intervals of the sensor device to exchange the batteries. Prior to data transmittal, the processor of the sensor device may determine the battery level and may estimate whether the battery level is sufficient for data transmittal. In case the battery level is not sufficient, the processor may provide an alarm/a notice via a communication interface to a further device to inform a user about the low battery level. Data transmittal may be delayed until the batteries are exchanged to avoid loss of data. The processor of the sensor device may further monitor the data transmittal to determine whether the data has been fully transmitted or may provide an indication, such as the file size, to the further device which can be used by the further device to determine whether the data has been fully transmitted. In case the data has not been fully transmitted, the processor of the sensor device may reinitiate data transmittal. The time point of data transmittal and the information concerning the data transmittal, such as duration, success, connection parameters, may be stored in the memory of the sensor device and may be provided to a further device via a communication interface previously described at a later point in time for data evaluation.

The data received from the sensor device is then processed in step 518 by the further device as described in connection with step 514. Use of a further device to process the detected or partially processed audio signal(s) may be beneficial if the computing power of the sensor device is not sufficient to perform the processing with a reasonable time frame or if the processing would require a large amount of energy with would reduce the lifetime of the batteries of the sensor device to an unacceptable time period, such as less than 3 years.

In steps 516 and 520, it is determined whether the fill level is to be determined with the processor of the sensor device or by the further device. This determination is made by the processor of the respective device according to its programming. It may be beneficial to determine the fill level using an external device to reduce the power consumption of the sensor device.

If in step 516, it is determined that the fill level is to be determined by the processor of the sensor device (corresponding to variant A of FIG. 5), a data driven model and optionally the processed audio signal(s)—in case the audio signal(s) were only partially processed by the sensor device—are provided to the processor of the sensor device in steps 522 and 524. The data driven model parametrized on historical audio signals, historical fill levels of liquids and historical digital representations of containers is provided to the computer processor via the communication interface. The data-driven model provides a relationship between the fill level of the liquid in the container and the detected or processed audio signal(s) and is derived from historical audio signal(s), historical fill levels of liquids in containers and historical digital representations of the containers. The historical digital representations of the containers preferably comprise data on the size of the container, in particular data on the filling volume of the container, data on the content of the container, data on the initial filing level, data on the age of the container, data on the use cycle of the container and any combination thereof. To increase accuracy of the determination, a plurality of data driven models may be existing which may have been trained on different parameters, such as the container size. In this case, a suitable model is selected based on the digital representation, in particular the container size, by the processor of the sensor device. In another example, a plurality of suitable data driven models may exist and the fill level may be determined with a part or all of the suitable data driven models. In this case, classifiers obtained from different models are stacked to increase the accuracy of the determination.

In one example, the data driven model(s) is/are stored in the memory of the sensor device and is/are retrieved by the processor optionally based on the digital representation of the container as previously described. In another example, the data driven model(s) is/are stored on an external data storage medium, such as a database, and retrieved—optionally based on the digital representation of the container—as previously described from the external data storage medium by the processor of the sensor device via the communication interface.

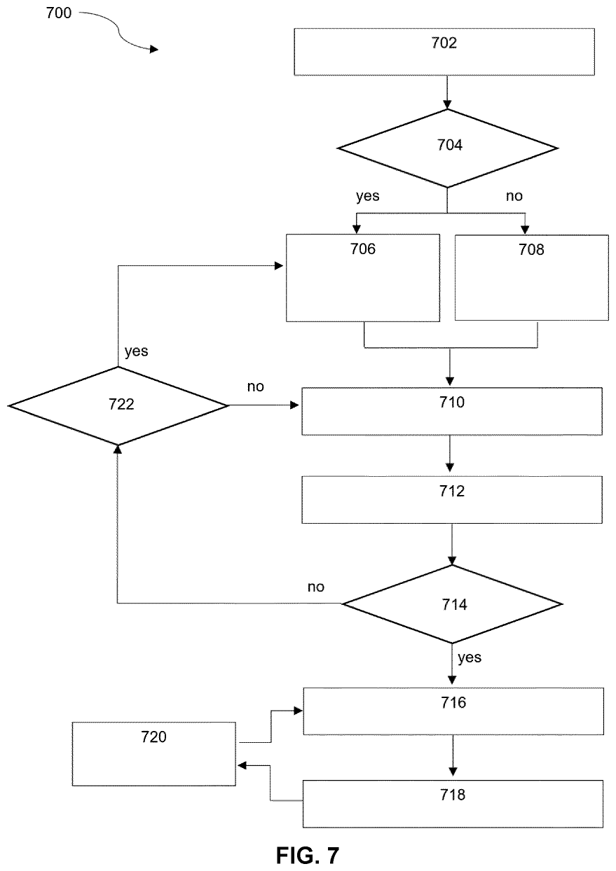

In this example, the data driven model(s) is a/are trained machine learning algorithm(s), in particular ensemble algorithms, such as a gradient boosting machines (GBM), gradient boosting regression trees (GBRT) and random forests. The training of the machine learning algorithm(s) may be performed as described in relation to FIG. 7.

The fill level of the liquid in the container is then determined by the processor of the sensor device using the data driven model(s) selected based on the digital representation of the container, the processed audio signal(s) and optionally data acquired by further sensors of the sensor device, such as the temperature and/or the location. In one example, the data driven model(s) use/uses data contained in the digital representation, such as data on emptying events, data on the fill level after filling of the container, etc., and data acquired by the climate sensor of the sensor device, such as temperature data, to improve the accuracy of the determination. In this example, the fill level is a classifier being “empty” or “not empty”, i.e. the actual fill level is not determined. Use of this classifier allows to reduce the complexity of the training data as well as the error level of the determination because accuracy is only needed with respect to the determination that the liquid in the container has been consumed and the fill level is “empty”. In another example, the determined fill level is corresponding to the actual fill level of the liquid in the container.

In step 528, the fill level determined with the processor of the sensor device is provided, for example via a communication interface. Providing the determined fill level may include displaying the determined fill level on a display device, such as a mobile or stationary display device including computers, laptops, tablets, smartphones etc., connected via the communication interface to the sensor device and/or storing the determined fill level on a data storage medium, such as a database or memory. The display device may comprise a GUI to increase user comfort and the fill level may be displayed graphically or using text. Moreover, coloring may be used in case the fill level is determined to be “empty”. The data storage medium may be the memory of the display device or may be present outside the display device, for example on a server or within the system described in relation to FIGS. 8 and 9. Storage of the determined fill level in the memory of the display device prior to transmittal to external devices avoids loss of data in case the communication interface is interrupted during data transfer. In one example, the determined fill level is transformed into a numerical variable or a descriptive output, each being indicative of the fill level of the liquid in the container, prior to providing the determined fill level of the liquid in the container via the communication interface. The numerical variable could be a single continuous variable that may assume any value between two endpoints. An example being the set of real numbers between 0 and 1. As a further example, the numerical variable could consider the uncertainty inherent in the data, for example in the detected or processed audio signal(s) and the output of the data driven model. An example being the range from 0 to 1, with a 1 indicating no uncertainty in the result. The output could also be transformed into a descriptive output indicative of the fill level of the liquid. In particular, the descriptive output could include an empty/not empty format.

If in step 516, it is determined that the fill level is to be determined remotely, i.e. with a further device (corresponding to variant B of FIG. 5), steps 530 to 538 are performed.

In step 530, the digital representation obtained in step 506 is provided by the sensor device via the communication interface to the further device. Data transfer may be accomplished as described in relation to step 518.

In step 532, the fully processed audio signal(s) and data acquired by further sensors of the sensor device is/are provided by the sensor device via the communication interface to the further device. Data transfer may be accomplished as described in relation to step 518.

In step 534, a data driven model is provided to the processor of the further device as described in relation to step 524. The data driven model(s) may be stored in a database and may be retrieved by the processor of the further device based on the digital representation of the container provided in step 530.

In step 536, the fill level is determined with the computer processor of the further device as described in relation to step 526.

In step 538, the determined fill level is provided as described in relation to step 528.

If in step 520, it is determined that the fill level is to not to be determined remotely, i.e. is to be determined with the sensor device (corresponding to variant A of FIG. 5), steps 522 to 528 are performed. In step 522, the fully or partially processed audio signal(s) as described in relation to step 518 are provided via the communication interface to the sensor device. The communication interface may be the same as described in relation to step 518. After the audio signal(s) are provided to the computer processor of the sensor device, steps 524 to 528 are performed as previously described.

If in step 520, it is determined that the fill level is to be determined remotely, i.e. is to be determined with a further device (corresponding to variant C of FIG. 5), steps 540 to 546 are performed. Steps 540 to 546 are identical to steps 530 and 534 to 538 previously described.

In one example, the method 500 may comprise repeating all steps beginning with step 506 or 508. Repeating may be performed at predefined time points or may be triggered by data received by the sensor device. Such data may include data informing the sensor device of an updated digital representation of the container, data on an emptying event, movement detected by the movement sensor, change in location or any combination thereof. It may be preferred to repeat these steps only if necessary to avoid unnecessary power consumption of the sensor device such that the lifetime of the batteries of the sensor device is increased.

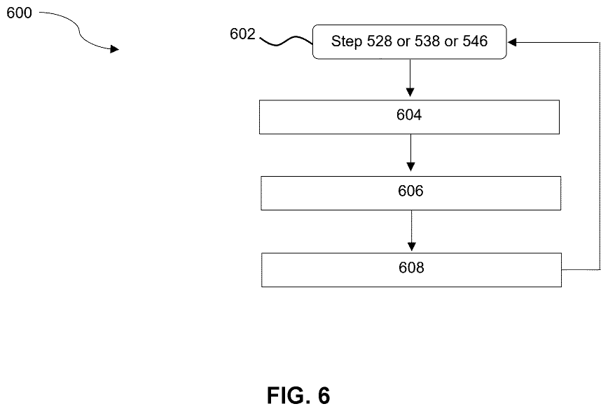

FIG. 6 is a block diagram of a preferred embodiment of the method. The method 600 includes all steps described in relation to FIG. 5 and further steps 604 to 608. For ease of reference, step 528, 538 or 546 of the method described in FIG. 5 is stated in FIG. 6 as step 602.

In step 604, an action is determined. In one example, the determination may be made by the processor of the sensor device according to its programming. This may be preferred if the fill level has also been determined by the processor of the sensor device. In another example, the action may be determined with a further device. The action may include: a transport date, a cleaning or filling date, discarding or maintenance of the container, ordering of new container(s), discarding container(s), changing the location of the container, powering down, powering up or adjusting behavior of the sensor device, activating an alarm (e.g., a visual, sound or noise), optimizing maintenance intervals, or any suitable combination of the foregoing. In determining the action, the processor may consider—apart from the determined fill level—the digital representation of the container and sensor data gathered by the sensors of the sensor device, such as movement data, climate data, location data and combinations thereof. Scheduling of transport of empty or filled containers may include determining consolidated transports as previously described to save transport costs. The scheduling may be performed automatically, i.e. without human intervention, based on the determined fill level and further data received from the sensor device. The optimization of maintenance intervals may be based on prediction of time points when the empty container will be returned based on determined fill levels. The prediction may include historical fill levels of the respective location/customer to increase accuracy of the prediction.

In step 606, the determined action is initiated. Initiation may include sending out instructions/data/alarms to the sensor device, further devices, or users. For example, once the consolidated transports have been determined, the respective orders for transport are sent to transport companies. It may be preferred to approve the determined consolidated transports by a user prior to sending out the respective orders to guarantee fulfilment of company specific requirements. Initiating may include further actions necessary by a user, such as approval processes, or other types of actions.

In step 608, the initiated actions are controlled. This guarantees that actions to be performed are indeed performed. Control can be performed by a computing device or a user, for example within an approval process or checking procedure. For this purpose, the user may be provided with all data used for the determination, the initiated action and data acquired after initiation of the action. It may be beneficial if the action can be corrected upon notice of mistakes or can be changed upon change of parameters used to determine the action. Correction or change may be performed manually by a user or may be initiated by a computing device upon receival of data acquired during performing the initiated actions.

Steps 604 to 608 may be repeated to guarantee that predefined actions are initiated once the determined fill level and optionally further sensor data fulfils predefined values.

FIG. 7 shows an illustrative process 700 to implement a machine learning algorithm, more specifically an ensemble learning algorithm, such as gradient boosting machines (GBM), gradient boosting regression trees (GBRT), random forests or a combination thereof, in one illustrative embodiment of method 500 using machine learning to train the algorithm to determine the liquid fill level of a liquid in a container. The algorithm can use the detected or processed audio signal(s) and optionally data detected by further sensors to determine and output a fill level.

The algorithm can be hosted by the sensor device, a remote server or a cloud or other server. Advantageously, by locating the algorithm on a remote server or a cloud server, costs of added memory and/or a more complex processor, and associated battery usage in using the algorithm to determine the fill level can be avoided for each sensor device. Additionally, continuous, or periodic improvement of the algorithm can more easily be done on a centralized server and avoid data costs, battery usage, and risks of pushing out a firmware update of the algorithm to each sensor device. A remote server may also serve as a central repository storing training and/or collections of operative data sent from various sensor devices to be used to train and develop existing algorithms. For example, a growing repository of data can be used to update and improve algorithms on existing systems and to provide improved algorithms for future use. An exemplary available software to implement process 7000 is scikit-learn (available on the Internet at https://scikit-learn.org), an open source machine learning library that runs on Windows, macOS and Linux, or XGBoost, an open source machine learning library that runs on Windows, macOS and Linux. Another exemplary commercially available software is MATHLAB (available on the Internet at mattworks.com) which provides classification ensembles in the Statistics and Machine Learning Toolbox. Examples of available software for ANN models is Keras (available on the Internet at Keras.io), an open source ANN model library that runs on top of either TensorFlow or Theano, which provide the computational engine required. TENS ORFLOW (an unregistered trademark of Google, of Mountain View, Calif.) is an open source software library originally developed by Google of Mountain View, Calif. and is available as an internet resource at www.tensorflow.org. Theano is an open software library developed by the Lisa Lab at the University of Montreal, Montreal, Quebec, Canada, and is available as an internet resource at deeplearning.net/software/theano/.

In Step 702, the input and outputs are selected. In case an artificial neural network (ANN) is used, the inputs and outputs refer to the number of data points in each of the input and output layers which will be separated in the ANN model by one or more layers of neurons. Any number of input and output data points can be utilized. In one example, there can be numerous data inputs, such as the spectrograms of each audio signal obtained after processing the generated audio signal(s) or combined features as previously described and one data output, such as a percentage for fill level of the liquid in the container, or two data outputs, such as a classifier being “empty” or “not empty”. In one example, the inputs can be structured to represent at least 15, in particular at least 20, spectrograms of each audio signal or less than 9000, in particular less than 300 or less than 50, combined features and measured environmental variables, such as the temperature. In this example, the combined features are obtained from the magnitudes of frequency and the phase of the frequency (i.e. the raw features described in relation to FIG. 5) by extracting the following features: the (normalized) average frequency, the (normalized) median frequency, the standard deviation of the frequency distribution and the skew of the frequency distribution The extracted features are then aggregated. In another example, the combined features are obtained by extracting at least one, in particular all, of the following features from the spectrogram of each audio signals: frequency with the highest energy, the (normalized) average frequency, the (normalized) median frequency, the deviation of the frequency distribution from the average or median frequency in different LP spaces, the spectral flatness, the (normalized) root-mean-square, fill-level specific audio coefficients, the fundamental frequency computed by the yin algorithm, the (normalized) spectral flux between two consecutive frames. The extracted features are then combined using principal component analysis (PCA) algorithms as previously described and the components of the PCA with the highest eigenvalues are used as combined features. The machine learning algorithm may be structured such that more or less input response samples and/or environmental samples can be utilized.

In step 704, it is determined whether a customized algorithm is required or not. Using customized algorithms being trained for particular conditions, such as a particular installation, container model or other varying condition may increase the accuracy of the determination. For example, if two different containers vary significantly in mechanical design and configuration, it is likely that a separate set of training data and a separate algorithm would need to be developed for each type of container. For example, it is likely that a different set of training data and possibly algorithm would need to be developed by process 700 for containers having different volumes or being single-walled or double-walled. If it is decided in step 704 that a customized algorithm is needed, the training set, validation set, and verification set for each algorithm has to be developed in step 706. Otherwise, a general training set, validation set, and verification set can be used in step 708.

In step 708, an algorithm training data set is developed and/or collected for use in the current machine learning application. A generally accepted practice is to divide the model training data sets into three portions: the training set, the validation set, and the verification (or “testing”) set. In case an ANN is used, the training set is used to adjust the internal weighting algorithms and functions of the hidden layers of the neural network so that the neural network iteratively “learns” how to correctly recognize and classify patterns in the input data. The validation set, however, is primarily used to minimize overfitting. The validation set typically does not adjust the internal weighting algorithms of the neural network as does the training set, but rather verifies that any increase in accuracy over the training data set yields an increase in accuracy over a data set that has not been applied to the neural network previously, or at least the network has not been trained on it yet (i.e. validation data set). If the accuracy over the training data set increases, but the accuracy over then validation data set remains the same or decreases, the process is often referred to be “overfitting” the neural network and training should cease. Finally, the verification set is used for testing the final solution in order to confirm the actual predictive power of the neural network.

In one example, approximately 70% of the developed or collected data model sets are used for model training, 15% are used for model validation, and 15% are used for model verification. These approximate divisions can be altered as necessary to reach the desired result. The size and accuracy of the training data set can be very important to the accuracy of the algorithm developed by process 700. For example, for an illustrative embodiment of method 500, about 40.000 sets of data may be collected, each set including spectrograms of audio frames or combined features as described previously, environmental data samples, and precise determination of fill level by commonly known methods, such as use of an ultrasonic sensor fixed above the filling hole, use of a time-of-flight sensor or a defined addition of liquid to or withdrawal of liquid from the container. The training data set may include samples throughout a full range of expected fill levels and environmental and other ambient conditions.

Further, as shown in Step 706, specifically tailored data sets can be collected for containers with known or relatively known properties (e.g. specific container models, styles, dimensions, and/or applications) to ensure the internal weights of the neural network or the algorithm is/are more appropriately trained such that the fill level determination is more accurate. For example, data is collected from a large number of containers, and is classified based upon the model of container it was collected from. The classified data is then used to train either the same or different algorithms to increase accuracy. The algorithm(s) specifically trained with this data set may then be selected for the determination of the fill level based on the provide digital representation of the container. The remote server may serve as a central repository to store and classify this data collected from a vast database of container types and unique fill level applications such that it can be used to locally or remotely develop, train, or retrain algorithms for existing or future fill level indication systems or related applications.

In Step 710 an ensemble learning algorithm, such as gradient boosting machines (GBM), gradient boosting regression trees (GBRT), random forests or a combination thereof, is selected. Optionally, the process 700 can be tailored for a selected number of algorithm types and/or dimensions to compare the accuracy and select a preferred algorithm for any particular container or related application. Guidelines known to those skilled in the art and/or associated with specific algorithm software can aid in the initial selection of the model type and dimensions.

In Step 712, the algorithm is pointed to the training and validation portions of the training data set. Training is an iterative process that—in case of ANNs—sets the internal weights, or weighting algorithms, between the ANN model neurons, with each neuron of each layer being connected to each neuron of each adjacent layer, and further with each connection represented by a weighting algorithm. With each iteration of training data to adjust the weights, the validation data is run on the ANN model and one or more measures of accuracy is determined by comparison of the model output for fill level with the actual measurement of fill level collected with the training data. For example, generally the standard deviation and mean error of the output will improve for the validation data with each iteration and then the standard deviation and mean error will start to increase with subsequent iterations. The iteration for which the standard deviation and mean error is minimized is the most accurate set of weights for that ANN model for that training set of data. In case of an ensemble learning algorithm, training is performed by modifying the parameters of each algorithm using bagging or boosting as previously described or by modifying the weighting of each classifier/regressor in the ensemble.

In Step 714, the algorithm is pointed to the verification data set and a determination of whether the output of the algorithm is sufficiently accurate when compared to the actual fill level measure with collection of the data. If the accuracy is not sufficient, process 700 can continue at step 716 or step 722 if any additional training models are needed. The process 700 is continued at step 722 if the algorithm verification was unsatisfactory, and it may be desirable to return to Step 706 or 708 to collect a larger and/or more accurate set of training data to improve the algorithm accuracy. The process is continued at Step 710 if it is desired to try to improve algorithm accuracy using the current training data set by selecting an algorithm of a different type and/or dimensions.

Once the algorithm has been selected and trained to sufficient accuracy, the algorithm is implemented in step 716. For example, in an illustrative embodiment, the algorithm is hosted in software form by a remote server. Alternatively, the algorithm could be hosted in hardware form and/or could be hosted by the sensor device, optionally with a wireless data connection to the remote server to receive updates or modifications to the locally-hosted algorithm if necessary.

Optionally, the algorithm can be improved over time with additional data. For example, in step 718, operational data (e.g., collections of spectrograms or combined features, environmental, and actual fill level data) can be collected from individual containers and, in step 720, used to further train and improve the algorithm for any particular container or application, essentially growing the aggregate training data set over time. This operational data can be compiled from a number of sources, including from the historical data the container itself has produced or from containers used in similar environments. This method of training fine-tunes the accuracy of the algorithm since the algorithm is receiving data specifically produced by the container it serves or from similarly situated containers.

One illustrative method of gathering this operational data is from customers who consume the liquid being present in the container. Once a container is filled to 100% capacity, an accurate set of data can be obtained, and the levels of the tank can be monitored moving forward. Each time the container is empty another accurate set of data can be obtained, and the collected data can be analyzed to confirm the algorithm output readings versus whether the container is indeed empty. After repeating this process through multiple container refills, the algorithm serving that particular type of container will collect enough verified data to be used to further train the algorithm and become smarter as machine learning is being advanced in each instance. For that reason, it can be found advantageous to initiate container fill readings to a more infrequent basis (e.g. once or twice per day) once the algorithm learns how to provide the most accurate readings.

FIG. 8 is an example of a system for determining the fill level of a liquid in a container according to embodiments of the system described therein. The system 800 comprises a metal single-walled IBC container 802 being present within a metal framework 804. In one example, the container is filled with a liquid coting composition, such as a liquid basecoat composition. In another example, the container is filled with a liquid cosmetic or liquid food composition. The system further includes an attachment means 806, such as the bar described in relation to FIGS. 4a and 4b, which is used to physically couple sensor device 810 to the outside of container 802. A suitable sensor device is, for example, described in relation to FIG. 2. The attachment means comprises an identification tag 808 having stored thereon the digital representation of the container or information being indictive of the representation, such as the container ID, as described in relation to FIGS. 4a and 4b. The system 800 further comprises at least one further computing device 818, for example a geographically remote server, such as a cloud-based server. In one example, the further computing device 818 is used to determine the fill level (see for example FIG. 5) and optionally actions as described below based on data transmitted from the sensor device via communication interfaces 826 and 828. For this purpose, the further computing device 818 may comprise trained machine learning algorithms as previously described, for example in relation to FIG. 7.

The further computing device 818 is connected with the sensor device via cellular communication interfaces 826, 828 making use of a mobile radio tower 816. In one example, the cellular communication interface 826 may be a LPWAN technology as described previously. In one example, cellular-based communication interface 826 and/or 828 exceeds the coverage capability of 900 MHz communication systems and eliminates the need to integrate with a WiFi network or other LAN and any associated issues, e.g. firewalls, changing passwords, or different SSIDs. The further computing device is connected with clients 820.1 to 820.3, such as mobile or stationary computing devices including laptops, smartphones, tablets, or personal computers, via communication interface 830. In one example, access to the further computing device 818 via clients 820.1 to 820.3 may be restricted using commonly known authorization procedures, such as single sign on. The further computing device 818 may perform further analysis of the transmitted and determined data, such as initiating and controlling an action as described in relation to FIG. 6. The data, associated analysis and initiated actions may be accessed and viewed, for example via a web browser, using clients 820.1 to 820.3, thus eliminating the need for a specialized computing device. The further computing device 818 can also interface with Enterprise Resource Planning or vendor managed inventory systems such that information is sent directly to the user's computing devices (such as clients 820.1 to 820.3) or that information present in a database used in the vendor managed inventory system is automatically updated by further computing device 818 which can then, in turn, be accessed by user's computing devices. To determine the location of the container, sensor device 810 may communication with a WiFi hotspot 812 via communication interface 822 and/or with a global navigation satellite system 814 via communication interface 824 as described previously. Data on the determined location may—along with data determined by further sensors of the senser device, such as the temperature—be transmitted via communication interfaces 826, 828 to the further processing device 818 as previously described.

In one example, the system 800 comprises a plurality of containers 802.1 to 802.n having attached thereto sensor devices 810.1 to 810.n. In one example, each sensor device 810.1 to 810.n transmits data via communication interface 826, 828 to the further computing device 818 and the further computing device 818 then processes all data received from the sensor devices. In another example, data from sensor devices 810.1 to 810.n is transmitted to different computing devices 818.1 to 818.n and further processed by these computing devices. Computing devices 818.1 to 818.n may then transmit the processed data to another computing device, which may be accessed by clients 820.1 to 820.n. Alternatively, client devices 820.1 to 820.n may access the respective computing device 818.1 to 818.n which processes relevant data from the sensor device.

FIG. 9 is a diagram illustrating an example of a system 900 for remotely monitoring and managing containers, according to embodiments of the method and system described herein. System 900 includes a cloud 902 having coupled thereto a plurality of sensor devices 918, 922, 926, 930 and clients 912, 914. The cloud 902 may include one or more servers, for example the computing device 818 described in relation to FIG. 8. The sensor devices 918, 922, 926, 930 are physically attached to containers 916, 920, 924, 928, for example as described in relation to FIG. 4b. Each of the sensor devices 918, 922, 926, 930 may be implemented as the sensor device 200 described in relation to FIG. 2.

Each of the sensor devices 918, 922, 926, 930 and clients 912, 914 are coupled via communication interfaces 932, 934, 936, 938, 940, 942 to cloud 902. In one example, at least part of the communication interfaces 932, 934, 936, 938, 940, 942 may represent gateways. Within this example, at least 2 sensor devices may be coupled via one gateway to the cloud 902 (not shown). In another example, sensor devices are coupled directly to the cloud 902. In this case, the sensor devices are configured with any of the gateway functionality and components described herein and treated like a gateway by cloud 902, at least in some respects. Each gateway may be configured to implement any of the network communication technologies described herein in relation to the sensor device 200 so the gateway may remotely communicate with, monitor, and manage sensor devices. Each gateway may be configured with one or more capabilities of a gateway and/or controller as known in the state of the art and may be any of a plurality of types of devices configured to perform the gateway functions defined herein. To ensure security of the transmitted data, each gateway may include a TPM (for example in a hardware layer of a controller) as described in relation to FIG. 2. The TPM may be used, for example, to encrypt portions of communications from/to sensor devices to/from gateways, to encrypt portions of such information received at a gateway unencrypted, or to provide secure communications between the cloud 902, gateways 932, 934, 936, 938, 940, 942, sensor devices 918, 922, 926, 930 and client devices 912, 914. For example, TPMs or other components of the system 900 may be configured to implement Transport Layer Security (TLS) for HTTPS communications and/or Datagram Transport Layer Security (DTLS) for datagram-based applications. Furthermore, one or more security credentials associated with any of the foregoing data security operations may be stored on a TPM. A TPM may be implemented within any of the gateways, sensor devices or servers in the cloud 902, for example, during production, and may be used to personalize the gateway or the sensor device. Such gateways, sensor devices and/or servers may be configured (e.g., during manufacture or later) to implement cryptographic technologies known in the state of the art, such as a Public Key Infrastructure (PKI) for the management of keys and credentials.

In one example, each gateway connecting a sensor device 918, 922, 926, 930 to the cloud 902 or each gateway present within a sensor device 918, 922, 926, 930 may be configured to process data received from a sensor device, including analyzing data that may have been generated or received by the sensor device, and providing instructions to the sensor device, as described in more detail in relation to FIG. 5 and elsewhere herein. In addition, each gateway may be configured to provide one or more functions pertaining to commissioning, filling, cleaning, incoming good inspections, and certification (e.g., after 2 years), consumption and other processing of containers as described in more detail in relation to FIG. 6. For this purpose, each gateway may be configured with software encapsulating such capability. In another example, sensor devices connected via a communication interface directly to cloud 902 may be configured to process data and perform further functions described above. For this purpose, the respective sensor device(s) may be configured with software encapsulating such capability. By performing such processing at one or more gateways, and/or at the sensor devices themselves, as opposed to in a more centralized fashion on one or more servers in the cloud 902, the system 900 may implement and enjoy the benefits of more distributed edge-computing techniques.

In this example, the cloud 902 comprises two layers, namely an application layer 906 containing one or more applications 904 and a service layer 910 containing one or more databases 908. The applications as well as the services layer 910 may each be implemented using one or more servers in the cloud 902. In another example, the cloud 902 comprises more or less layers. The service layer 910 may include, for example, the following databases 908: a transaction database, a container database, a container contents database, and lifecycle management database.

The transaction database may include one or more transaction records involving containers managed by the system 900. For example, transaction records may involve blockchain technology and the blockchain may serve as a secure transaction register for the system 900. Transactions may include any commercial transaction involving one of the managed containers or other status information not associated with a commercial transaction. Further, the data stored within each of the other databases 908 within the services layer 910 may be stored as one or more transaction records and may be part of the transaction register for the container management system 900.

The container database may include information about containers managed by the system 900 such as, for example, mechanical specifications, geometries, date of creation, maintenance intervals, last inspection, material composition and other information.

The container contents database may include information about the contents (e.g., liquids, bulk solids, powders) of the container being managed such as, for example, ingredients, chemical composition, classification (e.g., pharmaceutical, beverage, food), an ATEX classification of a container's contents or intended contents, regulatory-related information, properties of the container and other information collected over time, and other information about the contents. Properties of a container may include physical properties associated with a container, such as, for example, climate conditions, location, weight, and fill level, a maximum fill level of a container, as well as other properties. For a given container, the information stored in the container database and/or the container contents database may include the same information as is stored in the container itself, which in combination with the information about the container itself may be considered a digital representation of the container, e.g., a digital twin.

The lifecycle management database may store information about the states, rules, algorithms, procedures, etc. that may be used to manage the container throughout the stages of its lifecycle, as described in more detail elsewhere herein.

Information stored in the container database and/or container contents database may be retrieved by sensor device(s) 918, 922, 926, 930 via communication interfaces 934, 936, 938, 940 upon physical coupling of the sensor device(s) 918, 922, 926, 930 to the container (see FIGS. 4a and 4b). After physical coupling, the container ID stored on the NFC tag present on the attachment means is retrieved by means of the sensor device(s) 918, 922, 926, 930 and used to obtain information stored in the container database and/or container contents database which is associated with the container ID.

The transformation layer 906 may include any of a variety of applications that utilize information and services related to container management, including any of the information and services made available from the services layer 910. The transformation layer 906 may include: an inventory application, an order management application, further applications, or any suitable combination of the foregoing.

The inventory application may provide an inventory of containers managed within the system (e.g., the system 900), including properties (e.g., characteristics) about each container in the system, and the contents thereof, including the current state of the container within its lifecycle, a fill level of the container, current location (e.g., one or more network identifiers for a mobile telephony network, Wi-Fi network, ISM network or other) and any other properties corresponding to a container described herein. The inventory of containers may be a group (e.g., “fleet”) of containers owned, leased, controlled, managed, and/or used by an entity, such as an OEM.

The order management application may manage container orders of customers, for example, all customers of an entity, e.g., an OEM and/or orders of the OEM, for example for ordering new containers. The order management application may maintain information about all past and current container orders for customers of an entity or an OEM and process such orders. The order management application may be configured to automatically order containers for an entity (e.g., a customer or OEM) based on container status information received from sensor devices physically coupled to containers (e.g., via one or more gateways or directly from the sensor device itself). For example, the application may have one or more predefined thresholds, e.g., of empty containers, damaged containers, fill levels of containers, etc., after which being reached or surpassed (e.g., going below a fill level and/or number of non-empty and non-damaged containers) additional containers should be ordered. The applications may be configured via interfaces to interact with other applications within the application layer 906, including each other. These applications or portions thereof may be programmed into gateways and/or sensor devices of the container management network as well.

Container information may be communicated between components of the system 900, including sensor devices, gateways, and components of the cloud 902, in any of a variety of ways. Such techniques may involve the transmission of container information in transaction records, for example using blockchain technology. Such transaction records may include public information and private information, where public information can be made more generally available to parties, and more sensitive information can be treated as private information made available more selectively, for example, only to certain container producers, OEMs and/or customers. For example, the information in the transaction record may include private data that may be encrypted using a private key specific to a container and/or sensor device and may include public data that is not encrypted. The public data may also be encrypted to protect the value of this data and to enable the trading of the data, for example, as part of a smart contract. The distinction between public data and private data may be made depending on the data and the use of the data.

The number of communications between components of the system 900 may be minimized, which in some embodiments may include communicating transactions (e.g., container status information) to servers within the cloud 902 according to a predefined schedule, in which gateways are allotted slots within a temporal cycle during which to transmit transactions (e.g., transmit data from sensor device to cloud 902 or instructions from cloud 902 to sensor device(s)) to/from one or more servers. Data may be collected over a predetermined period of time and grouped into a single transaction record prior to transmittal.

1. A method for determining a fill level of a liquid in a container, said method comprising the steps of:
(i) attaching a sensor device to the container;
(ii) providing to a computer processor via a communication interface a digital representation of the container;
(iii) acoustically stimulating the container by means of the sensor device to generate at least one audio signal being indicative of the fill level of the liquid in the container;
(iv) detecting the generated audio signal(s) and optionally processing the detected audio signal(s);
(v) providing to the computer processor via the communication interface the detected or processed audio signal(s) being indicative of the fill level of the liquid in the container;
(vi) providing to the computer processor via the communication interface at least one data driven model parametrized on historical audio signals, historical fill levels of liquids in containers and historical digital representations of the containers;
(vii) determining, with the computer processor, the fill level of the liquid in the container based on the provided digital representation of the container, the provided audio signal(s) and the provided data driven model(s); and
(viii) providing via the communication interface the determined fill level of the liquid in the container.

2. The method according to claim 1, wherein the fill level of the liquid in the container is a classifier corresponding to the container being empty or the container not being empty.

3. The method according to claim 1, wherein the digital representation of the container comprises data on the size of the container, in particular data on the filling volume of the container, data on the content of the container, data on the initial filing level, filing date, data on the location of the container, data on the age of the container, data on the use cycle of the container, data on the maintenance intervals of the container, data on the maximum life time of the container, expiry date of container content, and any combination thereof.

4. The method according to claim 1, wherein the step of providing the digital representation of the container comprises
attaching an identification tag to the container,
retrieving the digital representation of the container stored on said attached tag or obtaining the digital representation of the container based on the information stored on said attached tag, and
providing the obtained digital representation of the container to the computer processor via the communication interface.

5. The method according to claim 1, wherein acoustically stimulating the container to generate at least one audio signal being indicative of the fill level of the liquid in the container includes beating on the outer wall of the container by means of the actuator of the sensor device to induce the at least one audio signal.

6. The method according to claim 1, wherein the at least one generated audio signal is detected with the at least one microphone of the sensor device.

7. The method according to claim 1, wherein processing the detected audio signal(s) comprises digitally sampling with the computer processor the audio signal(s) detected by the at least one microphone of the sensor device as a result of the acoustic stimulation of the container.

8. The method according to claim 7, wherein the audio samples are further processed with the computer processor by optionally aligning the audio sample(s), calculating a Fourier spectrum of the detected or aligned audio sample(s), optionally extracting at least one predefined feature from the Fourier spectrum and optionally combining the extracted features.

9. The method according to claim 8, wherein the predefined features are selected from the group consisting of frequency with the highest energy, the (normalized) average frequency, the (normalized) median frequency, the standard deviation of the frequency distribution, the skew of the frequency distribution the deviation of the frequency distribution from the average or median frequency in different LP spaces, the spectral flatness, the (normalized) root-mean-square, fill-level specific audio coefficients, the fundamental frequency computed by the yin algorithm, the (normalized) spectral flux between two consecutive frames and any combinations thereof.

10. The method according to claim 1, wherein the data driven model is derived from a trained machine learning algorithm.

11. The method according to claim 10, wherein the machine learning algorithm is trained by selecting inputs and outputs to define an internal structure of the machine learning algorithm, applying a collection of input and output data samples to train the machine learning algorithm, verifying the accuracy of the machine learning algorithm by applying input data samples of known fill levels and comparing the produced output values with expected output values, and modifying the parameters of the machine learning algorithm using an optimization algorithm in case the received output values are not corresponding to the known fill level.

12. The method according to claim 1, wherein providing the determined fill level of the liquid in the container via the communication interface comprises displaying the determined fill level of the liquid of the container on the screen of a display device.

13. A system for determining a fill level of a liquid in a container, comprising:
a container;
a sensor device for generating, detecting, and optionally processing at least one audio signal being indicative of the fill level of the liquid in the container;
a data storage medium storing at least one data driven model parametrized on historical audio signals, historical fill levels of liquids in containers and historical digital representations of the containers;
a communication interface for providing the digital representation of the container, the detected or processed audio signal(s) and at least one data driven model to the computer processor;
a computer processor (CP) in communication with the communication interface and the data storage medium, the computer processor programmed to:
a. receive via the communication interface the digital representation of the container, the detected or processed audio signal(s) and the at least one data driven model;
b. optionally process the received detected audio signal(s);
c. determine the fill level of the liquid in the container based on the received digital representation of the container, the received detected or processed audio signal and the received data driven model(s); and
d. provide the determined fill level of the liquid in the container via the communication interface.

14. A method comprising using the method of claim 1 for
optimizing the maintenance interval of container(s) and/or
reducing the total amount of circulating containers by consolidating transportation of empty and/or full containers and/or
reducing the product cycle and/or
ordering of new container(s) and/or
taking old containers out of service.

15. A container comprising a fill level of a liquid, wherein the fill level of the liquid is determined according to the method of claim 1.
